(19) United States
(12) Patent Application Publication
(10) Pub. No.: US 2004/0261010 A1
(43) Pub. Date: Dec. 23, 2004

(54) Web page creation apparatus, Web page creation method, Web page creation program and recording method

(76) Inventor: Takaya Matsuishi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/814,273

(22) Filed: Apr. 1, 2004

(30) Foreign Application Priority Data
Apr. 1, 2003 (JP) NO.2003-098112
Mar. 16, 2004 (JP) NO.2004-074962

(51) Int. Cl. G09G 5/00

(52) U.S. Cl. 715/501.1; 715/513; 715/526; 715/522

(57) ABSTRACT

In a Web page creation apparatus, a Web page creation unit creates a Web page having operation items. The Web page creation unit creates the Web page based on operation-item display information, which is defined for a device where the Web page is displayed or a user of the device to indicate whether the displaying of each operation item is needed, so that some of the operation items the displaying of which is needed are displayed.

### BACKGROUND OF THE INVENTION

1. Field of The Invention

The present invention relates to a Web page creation apparatus, a Web page creation method, a Web page creation program and a recording medium in which a Web page having operation items, displayed on a computer screen, is created.

2. Description of The Related Art

As one of GUI (graphical user interface) components in the screen of the application program, the menu is provided so that the operation items are displayed by clicking a predetermined position on the screen with the mouse. The menu includes a pull-down menu and a context menu, etc.

For example, the pull-down menu is arranged on the menu bar in the screen and displays the list of operation items such as “file”, “edit”, etc. in order to provide the user with the interface for starting the desired function intelligibly. The operation items are classified for every category of operation, and the user performs the classified function which is related to the category concerned for every menu.

Conventionally, the non-Web application program is provided with the menu as the GUI components, and the operation items displayed on the computer screen are varied dynamically. For example, when the user who is permitted only to make reference to the information but not permitted to update the information uses the application program, the operation item concerning the retrieval of the information is displayed and the operation item concerning the updating of the information is not displayed.

This capability helps the prevention of the occurrence of operational error by the user and the improvement of the operability of the application program. Conventionally, the capability is limited to the non-Web applications, such as Windows (registered trademark) based applications. It is difficult for the Web applications to dynamically vary the operation items of the menu on the Web page displayed on the computer screen.

That is, the logic which controls the GUIs is incorporated in the non-Web applications of the client side, and it is easy to dynamically vary the displaying of the operation items on the client computer.

However, the Web page is a mere HTML (hypertext markup language) data, and the contents of the Web page being displayed on the computer are determined by the Web server. Hence, the incorporating method that is the same as in the Windows based applications cannot be adapted to the Web applications.

Therefore, the method which is common to the Web applications is that, when the operation item of the Web page the execution of which is not permitted to the user, or the operation item corresponding to the function the execution of which is impossible is displayed and the user erroneously selects the operation item concerned, the Web server determines whether the execution of the selected function is possible, and notifies the client of an error if the execution is impossible.

However, in the case of the above-mentioned method, the user recognizes that the operation concerned cannot be performed only after choosing the operation item and receiving the notification of the error. There is the problem that the above-mentioned method may cause the user to perform useless operation.

Moreover, if the display information concerning the operation items corresponding to the functions which cannot be used by the user is included in the Web page, the data size of the Web page is increased unnecessarily, and there is the problem that the increasing of the traffic between the Web server and the client is caused.

In recent years, with the development of Web technology, the proliferation of Web applications has been seen. There is the increasing demand that the user who is accustomed to the non-Web applications has the operability of the Web applications equivalent to the conventional non-Web applications.

### SUMMARY OF THE INVENTION

An object of the present invention is to provide a novel and useful Web page creation apparatus in which the above-described problems are eliminated.

Another object of the present invention is to provide a Web page creation apparatus, a Web page creation method and a computer program product which create a Web page with which the operation items displayed on the computer are varied dynamically according to predetermined conditions.

The above-mentioned objects of the invention are achieved by a Web page creation apparatus comprising: a Web page creation unit creating a Web page having operation items, the Web page creation unit creating the Web page based on operation-item display information, which is defined for a device where the Web page is displayed or a user of the device to indicate whether the displaying of each operation item is needed, so that some of the operation items the displaying of which is needed are displayed.

Since the Web page is created based on the information about the necessity of the displaying of operation items defined by the Web page creation apparatus corresponding to a device or a user who displays the Web page, it is possible to create the Web page with which the operation items corresponding to the device or the user displayed are varied.

The above-mentioned objects of the invention are achieved by a Web page creation apparatus comprising: a Web page creation unit creating a Web page having operation items corresponding to functions of an external device; and an inquiry unit transmitting an inquiry about usable functions of the external device to the external device, wherein the Web page creation unit creates the Web page based on both operation-item display information, which is defined for a device where the Web page is displayed or a user of the device to indicate whether displaying of each operation item is needed, and usable function identification information, which is received from the external device in response to the inquiry of the inquiry unit and indicates the usable functions of the external device, so that the operation items corresponding to the usable functions of the external device are displayed.

In the above-mentioned Web page creation apparatus, the inquiry as to whether the processing corresponding to the operation items can be performed is sent to the server, and the Web page is created based on the response from the server concerning the processing corresponding to the operation items. Therefore, it is possible to create the Web page with which the operation items displayed on the device are varied dynamically according to the allowability of execution of the processing in the server.

The above-mentioned objects of the invention are achieved by a Web page creation apparatus comprising: a Web page creation unit creating a Web page having operation items corresponding to functions of different external devices respectively; and a permitted-function inquiry unit transmitting an inquiry about allowability of execution of a corresponding one of the functions for one of the operation items, to each of the external devices, wherein the Web page creation unit creates the Web page based on both operation-item display information, which is defined for a device where the Web page is displayed or a user of the device to indicate whether displaying of each operation item is needed, and permitted-function identification information, which is received from the external devices in response to the inquiry of the permitted-function inquiry unit and indicates the allowability of execution of each of the functions, so that the operation items corresponding to the permitted functions of the external devices are displayed.

In the above-mentioned Web page creation apparatus, it is possible to create the Web page with which the operation items displayed on the device are varied according to the state of the server corresponding to the operation items.

Moreover, in order to achieve the above-mentioned objects, the computer program product of the invention may be configured to cause a computer to perform a Web page creation method which creates a Web page with which the operation items displayed on the device are varied dynamically according to the predetermined conditions.

According to the present invention, it is possible to create the Web page with which the operation items displayed on the computer are varied dynamically according to the predetermined conditions.

### BRIEF DESCRIPTION OF THE DRAWINGS

Other objects, features and advantages of the present invention will be apparent from the following detailed description when read in conjunction with the accompanying drawings.

FIG. 1 is a block diagram of a Web system to which an embodiment of the Web page creation apparatus of the invention is applied.

FIG. 2 is a block diagram of a hardware composition of the Web server in the Web system of FIG. 1.

FIG. 3 is a block diagram of a software composition of the Web server in the Web system of FIG. 1.

FIG. 4 is a diagram showing an example of the display of the Web page created by the Web server in the present embodiment.

FIG. 5 is a block diagram of a Web page creation function of the Web server in the present embodiment.

FIG. 6 is a diagram showing an example of the definition of the all-menu-item XML in the present embodiment.

FIG. 7 is a diagram showing an example of the definition of the all-menu-item XSL in the present embodiment.

FIG. 8 is a diagram showing an example of the definition of the profile XML in the present embodiment.

FIG. 9 is a sequence diagram for explaining the processing of the Web server in a first preferred embodiment of the invention.

FIG. 10 is a diagram for explaining the processing of the menu creation module in the present embodiment to create the extraction XSL.

FIG. 11 is a diagram showing an example of the definition of the extraction XSL in the present embodiment.

FIG. 12 is a diagram for explaining the processing of an XSLT processor to create the dynamic menu-item XSL in the present embodiment.

FIG. 13 is a diagram showing an example of the definition of the dynamic menu-item XSL in the present embodiment.

FIG. 14 is a diagram for explaining the processing of the XSLT processor in the present embodiment to create the dynamic menu-item HTML.

FIG. 15 is a diagram showing an example of the display in which the menu items are customized for each user.

FIG. 16 is a sequence diagram for explaining the processing of the Web server in a second preferred embodiment of the invention.

FIG. 17 is a diagram showing an example of the definition of the profile XML in the present embodiment.

FIG. 18 is a diagram showing an example of the definition of the dynamic menu-item XSL in the present embodiment.

FIG. 19 is a diagram showing an example of the definition of the all-menu-item XML acquired from the document managing server in the present embodiment.

FIG. 20 is a diagram showing an example of the display of the menu items in the present embodiment.

FIG. 21 is a diagram showing an example of the display of the menu items corresponding to the document output menu in the present embodiment.

FIG. 22 is a diagram for explaining a correspondence of the menu items and the respective servers in the present embodiment.

FIG. 23 is a sequence diagram for explaining the processing of the Web server in a third preferred embodiment of the invention.

FIG. 24 is a diagram showing an example of the definition of the profile XML in the present embodiment.

FIG. 25 is a diagram showing an example of the definition of the all-menu-item XSL in the present embodiment.

FIG. 26 is a diagram showing an example of the definition of the dynamic menu-item XSL in the present embodiment.

FIG. 27 is a diagram showing an example of the definition of the all-menu-item template XML in the present embodiment.

FIG. 28 is a diagram showing an example of the definition of the all-menu-item XML created by the Web server in the present embodiment.

FIG. 29 is a diagram showing an example of the display of the menu items in the present embodiment.

FIG. 30 is a block diagram of an image forming apparatus which is provided with the Web page creation function in the present embodiment.

### DETAILED DESCRIPTION OF PREFERRED EMBODIMENTS

A description will now be provided of the preferred embodiments of the present invention with reference to the accompanying drawings.

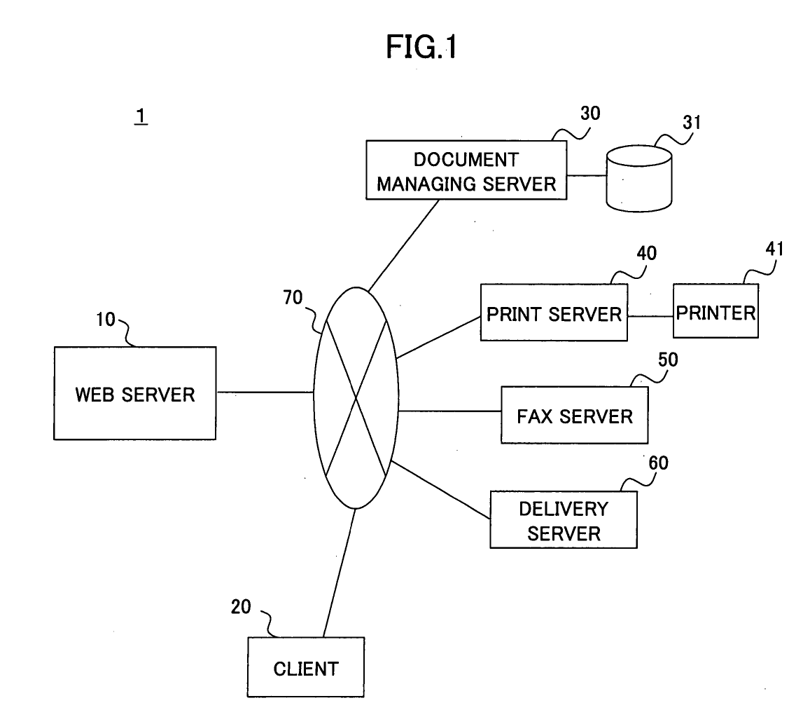

FIG. 1 shows the composition of a Web system to which an embodiment of the Web page creation apparatus of the present invention is applied.

As shown in FIG. 1, the Web system 1 in this embodiment includes the Web server 10, the client 20, the document managing server 30, the print server 40, the fax server 50, and the delivery server 60, and each component is connected through the network 70, such as the Internet or LAN (local area network).

The Web server 10 is the computer which creates a Web page with which the information requested by the client 20 is displayed, and provides the created Web page to the client 20.

The Web page in this meaning is the data of HTML or XML (extendible markup language) format which can be displayed by the general-purpose web browser, and extends to the structured document data for displaying data items described in a predetermined language, such as CHTML (compact HTML), WML (wireless markup language), etc.

The terminal 20 is a PC (personal computer), a PDA (personal digital assistant) or a communication terminal, such as a mobile phone, which is provided with the web browser for viewing the Web page provided by the Web server 10.

The document managing server 30 is the server provided with the document DB (database) 31 which is the database which manages document data, and provides the functions, such as the retrieval and updating of the document DB 31.

The print server 40 is the server which provides the printing function of document data. The print server 40 outputs the document data to the printer 41 when a printing request of the document data is received.

The fax server 50 is the server which provides the facsimile transmitting function of document data. The delivery server 60 is the server which provides the delivering function of document data to the specified user by the e-mail or the like.

In addition, the respective functions of the document managing server 30, the print server 40, the fax server 50 and the delivery server 60 can be called by using the RPC (remote procedure call) of the SOAP (simple object access protocol).

Next, a description will be given of the Web server 10.

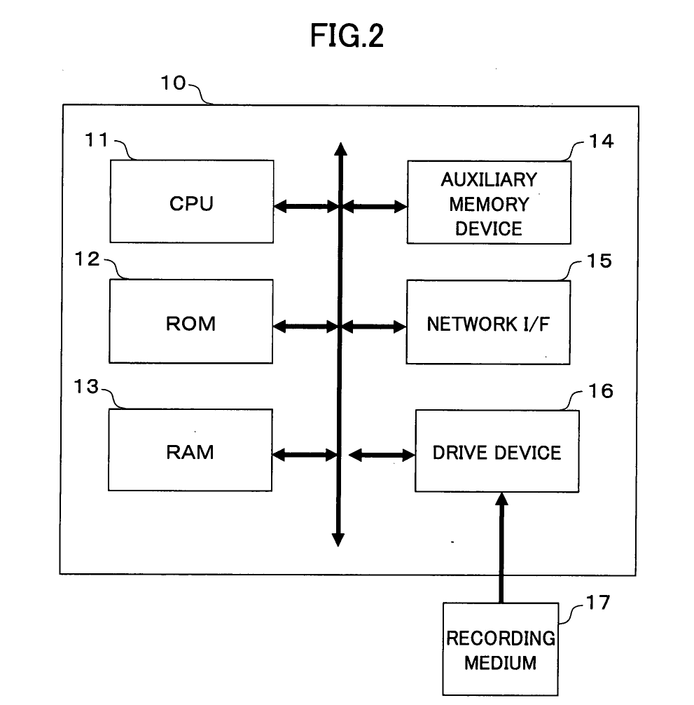

FIG. 2 shows a hardware composition of the Web server in the preferred embodiment of the invention.

As shown in FIG. 2, the Web server 10 comprises the CPU 11, the ROM 12, the RAM 13, the auxiliary memory device 14, the network interface (I/F) 15, and the drive device 16.

The CPU 11 is a control unit which controls the entire Web server 10. The CPU 11 performs various control programs and application programs stored in the ROM 12 or the auxiliary memory device 14, and carries out the control of the device, the communicative control, and the acquisition and editing of data.

The ROM 12 is a storage device which mainly stores the control programs of the device, and the RAM 13 is a storage unit which is used as the work memory of the CPU 11 and the temporary data storage.

The auxiliary memory device 14 is a storage device which stores the various application programs and data, and stores the files if needed. The network I/F 15 is the interface for connecting the Web server 10 to the network 70. The drive device 16 is the device for reading the recording medium 17, such as a CD-ROM on which the program which executes the function of the invention is recorded.

In the present embodiment, neither the operation unit nor the display device is shown in the composition of FIG. 2. Alternatively, the Web server 10 may be provided with the operation unit, such as the keyboard, the mouse, etc. and the display device, such as the LCD (liquid crystal display), and the CRT (cathode ray tube) display, etc. In such alternative embodiment, the receiving of the input from the user and the displaying of the operational results can be realized.

Next, a description will be given of a software composition of the Web server 10.

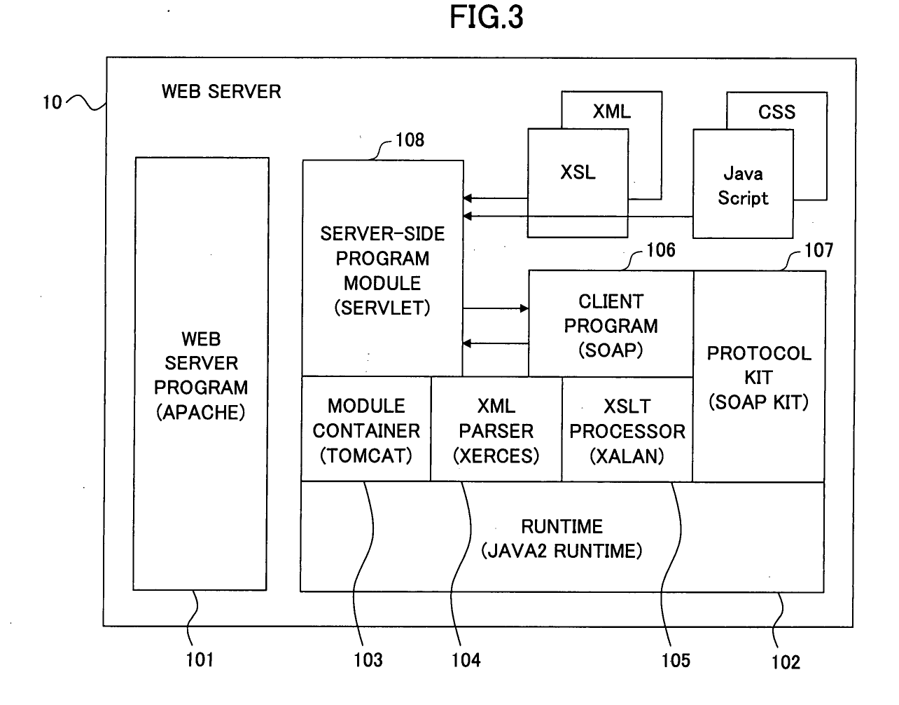

FIG. 3 shows a software composition of the Web server in the preferred embodiment of the invention.

As shown in FIG. 3, the Web server 10 is provided with the software including the Web server program 101, the runtime 102, the module container 103, the XML parser 104, the XSLT processor 105, the client program 106, the protocol kit 107, and the server side program module 108.

And the above-described software is stored in the auxiliary memory device 14 or the ROM 12, and when the CPU 11 is requested, it is read and performed. Alternatively, it is possible to make it acquire such software from the exterior through the network I/F 15.

Among these, the Web server program 101 is the software for transmitting the Web page according to the request from the client 20 in the Web system 1. For example, the Apache currently provided by the Apache Software Foundation may be used as the Web server program 101.

The runtime 102 is the software module needed when the application program is executed, and the Java2 (registered trademark) runtime is used for performing the application program created by the programming language called the Java2 provided by the Sun Microsystems Co.

The module container 103 is the software which provides the execution environment for performing the server side program module 108. For example, the Tomcat currently provided by the Apache Software Foundation can be used as the module container 103.

The XML (extensible markup language) parser 104 is the software provided to develop the XML data described in text into the memory in a tree structure, and it is made easy to deal with other application programs. For example, the Xerces currently provided by the Apache Software Foundation can be used as the XML parser 104.

The XSLT (extensible stylesheet language transformation) processor 105 is the software for transforming the XML data according to the XSL data. For example, the Xalan currently provided by the Apache Software Foundation can be used as the XSLT processor 105.

The client program 106 is the software for requesting the processing to the SOAP server, such as the document managing server 30. For example, the software which performs the communication procedure by the SOAP can be used as the client program 106. Moreover, the protocol kit 107 is the software for actually performing the communications according to the request.

The server-side program module 108 is the program which is performed on the Web server and arranged in the module formation. In the present embodiment, the Servlet created using the Java2 language is used as the server-side program module 108.

Most of the processings in the present embodiment of the Web server 10 are realized by causing the CPU 11 to function as the various units in accordance with the server-side program module 108. That is, the server side program module 108 serves as the program for carrying out the calling of the functions of the document managing server 30 and the Web page creation according to the request from the client 20.

In addition, when transforming the XML data according to the XSL data to create the HTML data as in the Web server 10, the codes by the Java Script for specifying the error operation in the pop-up, and the Cascading StyleSheet (CSS) data for specifying the displaying method not covered by the specifications of HTML and XSL, may be used collectively. The required CSS data and Java Script codes may be included directly in the XSL data, or the reference information of such data and codes may be included in the XSL data. Hence, the required CSS data and Java Script codes maybe included in the XSL data which are the transformed data.

The functions to create the Web page which is provided to the client 20 are incorporated in the Web server 10 of the present embodiment based on the hardware and software composition described above.

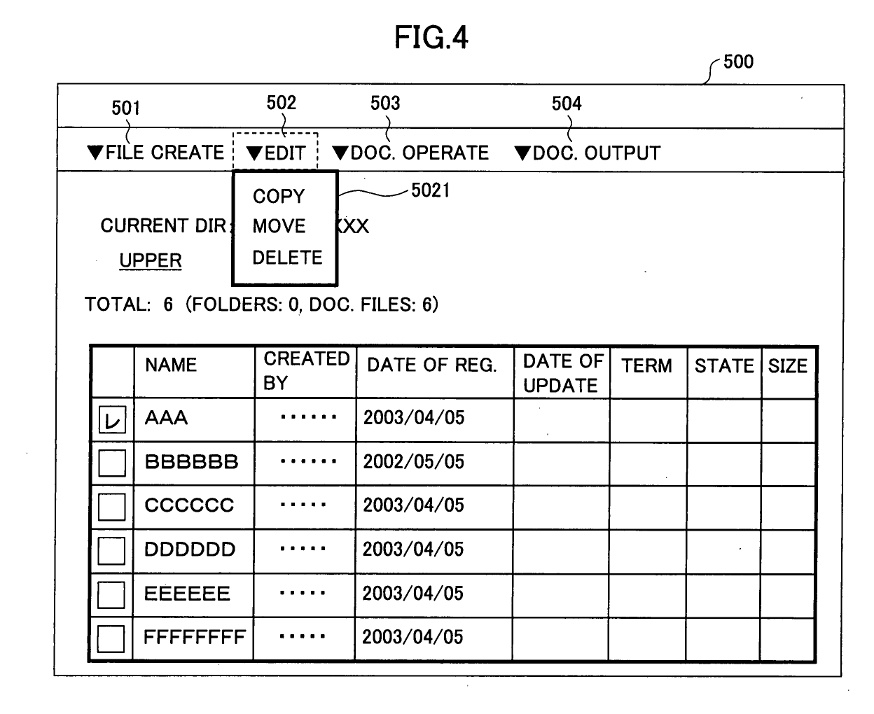

FIG. 4 shows an example of the display of the Web page created by the Web server in the present embodiment.

As shown in FIG. 4, the document list page 500, which is the Web page to display the list information of document data, contains the menus including the file creation menu 501, the edit menu 502, the document operation menu 503, and the document output menu 504 for every category of operation.

In-the example of FIG. 4, the state in which the edit menu 502 among the menus is opened is shown. In the opened edit menu 502, the menu-item list 5021 including the “copy”, “move” and “delete” menu items is displayed.

In the following description, in order to simplify explanation, one menu (the edit menu 502) among two or more menus displayed on the document list page 500 will be described.

Next, a description will be given of an example of the function of the Web page creation in the Web server 10.

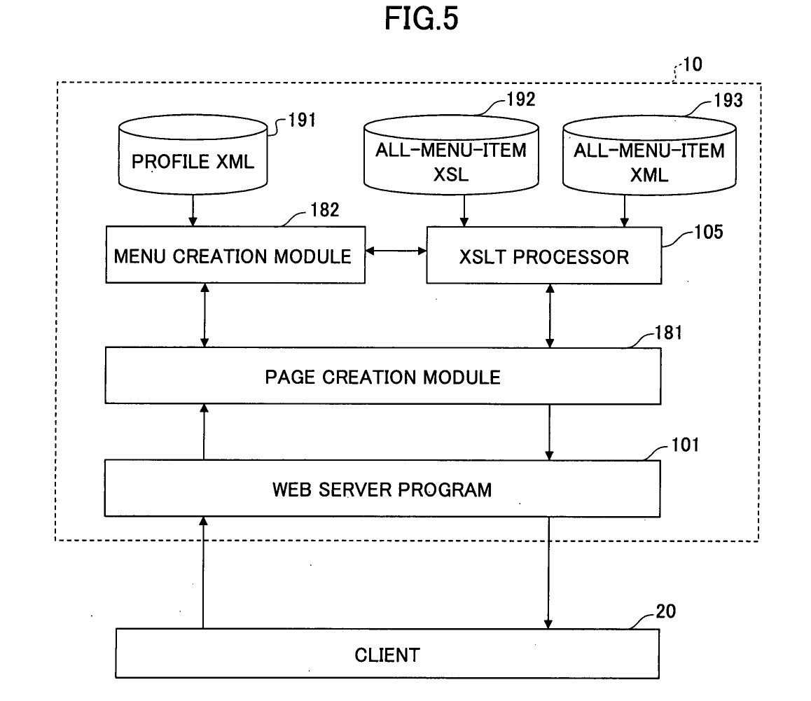

FIG. 5 is an example of the Web page creation function of the Web server in the present embodiment. The Web page creation function of FIG. 5 is realized by the server side program module 108 of FIG. 3 in the present embodiment.

As shown in FIG. 5, the Web page creation function of the Web server 10 mainly includes the Web server program 101, the page creation module 181, the menu creation module 182, the XSLT processor 105, the profile XML 191, the all-menu-item XSL 192, and the all-menu-item XML 193.

The page creation module 181 is the module which controls the processing to create a single Web page. In the example of FIG. 5, the page creation module 181 is illustrated as one block. However, two or more instances of the page creation modules 181 are provided for every kind of the Web page.

The menu creation module 182 is the module which creates the style information (XSL data) of the menu item based on the request from the page creation module 181. In addition, the style information created by the menu creation module 182 is used in creating the Web page by the page creation module 181.

The all-menu-item XML 193 is the data of XML format which contains the information for identifying the processing which should be performed for all the menu items that can be displayed on the document list page 500 when each of the menu items is chosen.

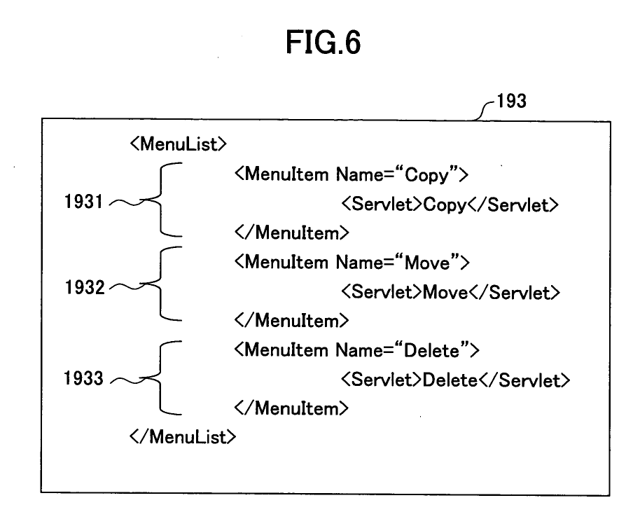

FIG. 6 shows an example of the definition of the all-menu-item XML in the present embodiment.

In the all-menu-item XML 193 of FIG. 6, the description 1931 includes the definition corresponding to the copy menu item among the menu-item list 5021 of FIG. 4. That is, when the value of the Name attribute in the MenuItem tag in the description 1931 is “Copy”, it is determined that the definition of the description 1931 corresponds to the copy menu item.

Similarly, the description 1932 includes the definition corresponding to the move menu item, and the description 1933 includes the definition corresponding to the delete menu item.

In the all-menu-item XML 193 of FIG. 6, the definitions of the menu items belonging to the other menus different than the edit menu 502 are also included. However, they are omitted in FIG. 6 for the sake of simplicity of description.

In each definition of the description 1931, the character string surrounded with the Servlet tag is for identifying the processing which should be performed when the menu item concerned is chosen. That is, when the copy menu item is chosen, the Web server 10 determines that the processing identified by the character string “Copy” should be performed.

Referring back to FIG. 5, the all-menu-item XSL 192 is the data of XSL format that defines the style information for all the menu items. Therefore, the HTML data which is used to display all the menu items is created by carrying out the XSL transform with the application of the all-menu-item XSL 192 to the all-menu-item XML 193.

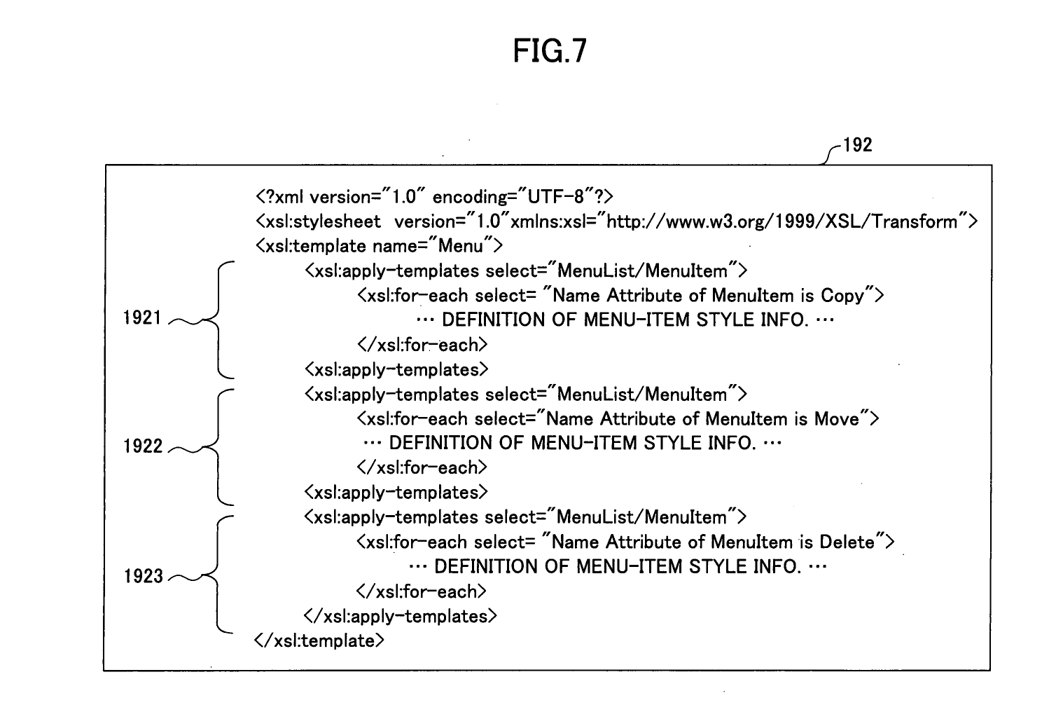

FIG. 7 shows an example of the definition of the all-menu-item XSL in the present embodiment.

As shown in FIG. 7, the style information of the menu items which can be displayed on the edit menu 502 is defined in the all-menu-item XSL 192. The description 1921 includes the style information corresponding to the copy menu item, and the description 1922 and the description 1923 include the style information corresponding to the move menu item and the style information corresponding to the delete menu item, respectively.

Referring back to FIG. 5, the profiles XML 191 is the data of XML format which contains the information concerning the necessity of the display of each of the menu items for each user.

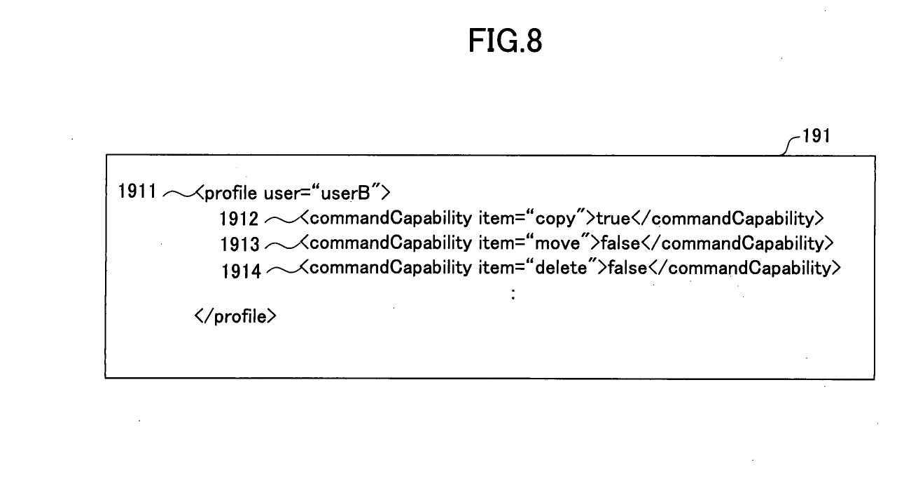

FIG. 8 shows an example of the definition of the profile XML in the present embodiment. In the profile XML 191 of FIG. 8, the description 1911 includes the identification information of the user corresponding to the profile XML 191. Namely, based on the description 1911 including the statement “profile user=“userB” ”, it is determined that the profile XML 191 corresponds to the user who has the account of “userB”.

In the descriptions 1912-1914, the definition as to whether each of the menu items should be displayed is included. That is, the corresponding menu item is determined in accordance with the value of the item attribute of the commandCapability tag, and it is determined whether the displaying of the menu item concerned is necessary, in accordance with the value surrounded by the commandCapability tag.

In addition, the description 1912 corresponds to, the copy menu item, and the setting (true) indicating that the displaying of the copy menu item is necessary is defined. The description 1913 and the description 1914 correspond to the move menu item and the delete menu item, respectively, and the setting (false) indicating that the displaying of the respective menu items is unnecessary is defined.

Next, a description will be given of the procedure performed by the Web server of FIG. 5.

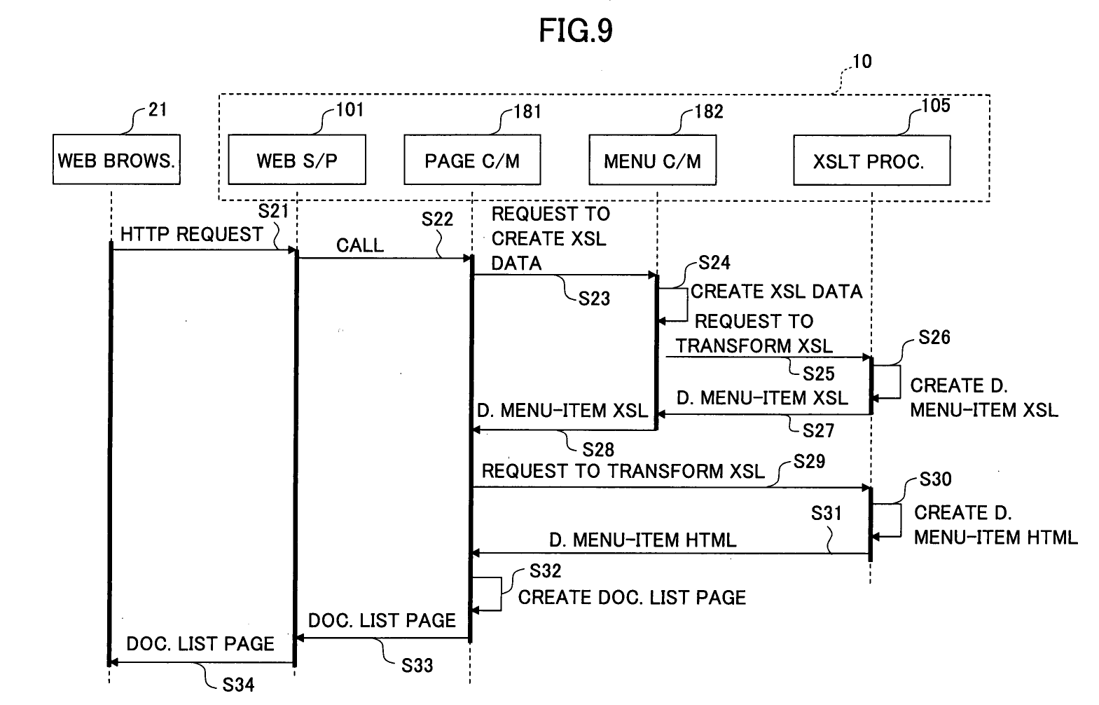

FIG. 9 is a sequence diagram for explaining the processing of the Web server in the first preferred embodiment of the invention.

If the user of the client 20 inputs the URL of the document list page 500 into the web browser 21, the web browser 21 transmits a request (HTTP request) of acquisition of the document list page 500, to the Web server 10 (S21).

Progressing to step S22 following step S21, the Web server program 101 of the Web server 10, which received the HTTP request, calls the page creation module 181 corresponding to URL. Therefore, the page creation module 181 for creating the document list page 500 is called.

Progressing to step S23 following step S22, the page creation module 181 sends a request of creation of the XSL data (called “dynamic menu-item XSL”), with which only the style information of the menu item allowed for the display of the document list page with respect to the user is defined, to the menu creation module 182.

Progressing to step S24 following step S23, the menu creation module 182 creates the extraction XSL 171 based on the definition of the profile XML 191. In the created extraction XSL 171, the style information for extracting only the definition of the menu items, which should be displayed on the Web server, from the all-menu-item XSL 192 is defined.

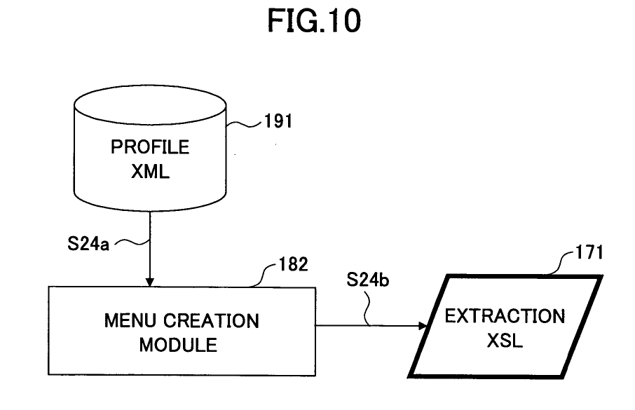

FIG. 10 shows the processing of the menu creation module 182 to create the extraction XSL in the present embodiment. As shown in FIG. 10, the menu creation module 182 reads the profile XML 191 (S24a), and creates the above-described extraction XSL 171 based on the read profile XML 191 (S24b).

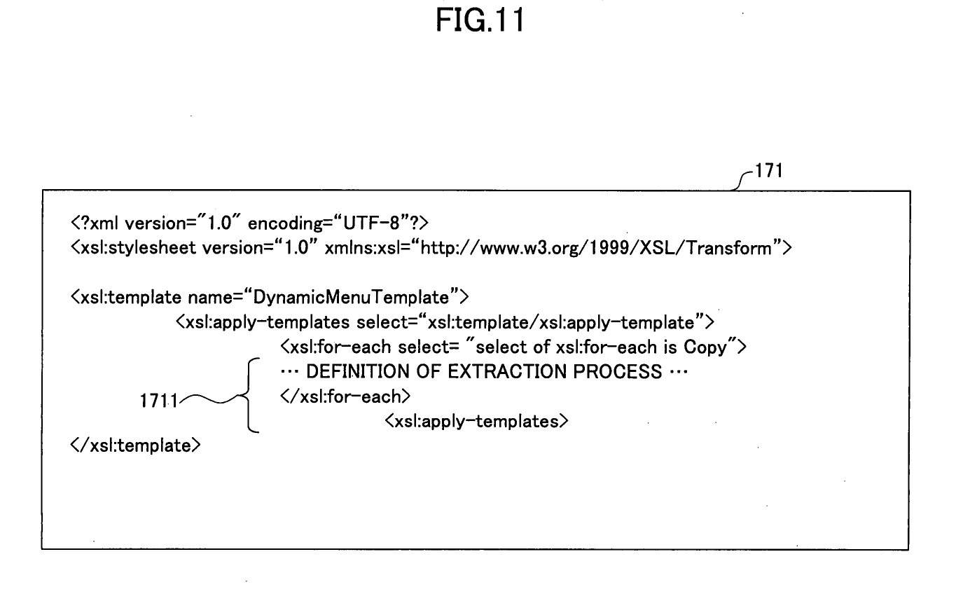

FIG. 11 shows an example of the definition of the extraction XSL. In the example of the definition of the extraction XSL 171 of FIG. 11, the description 1711 includes the definition for extracting the definition (the description 1921 of FIG. 7) corresponding to the copy menu item from the all-menu-item XSL 192.

However, it does not include the definition corresponding to each of the move menu item and the delete menu item. This is because the setting (false) indicating that the displaying of the move menu item and the delete menu item is unnecessary is defined in the profile XML 191.

Progressing to step S25 following step S24, the menu creation module 182 specifies the arguments of the extraction XSL 171 created in step S24 and the all-menu-item XSL 192 stored in advance, and calls the XSLT processor 105.

Progressing to step S26 following step S25, the XSLT processor 105 performs XSL transform with the application of the extraction XSL 171 to the all-menu-item XSL 192, extracts the definition corresponding to only the menu items made applicable to the display, from the all-menu-item XSL 192, and outputs the resulting dynamic menu-item XSL.

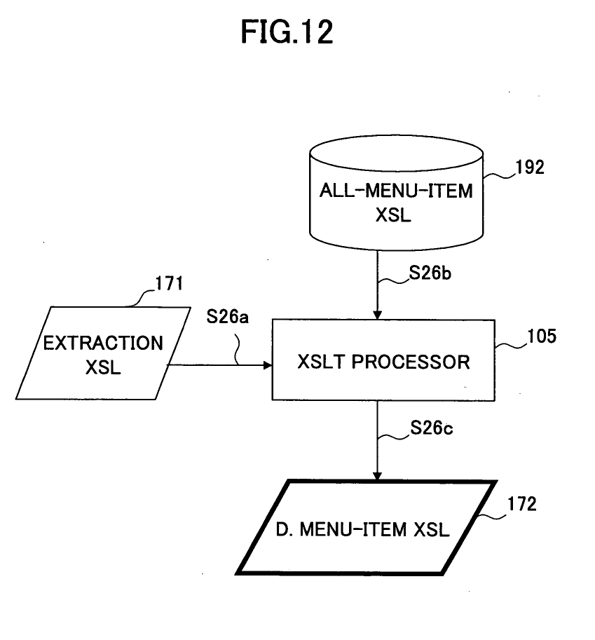

FIG. 12 shows the processing of the XSLT processor to create the dynamic menu-item XSL in the present embodiment.

As shown in FIG. 12, the XSLT processor 105 reads the extraction XSL 171, and the all-menu-item XSL 192 (S26a, S26b), and performs the XSL transform with the application of the extraction XSL 171 to the all-menu-item XSL 192, and signs that dynamic menu-item XSL 172 is created are shown (S26c).

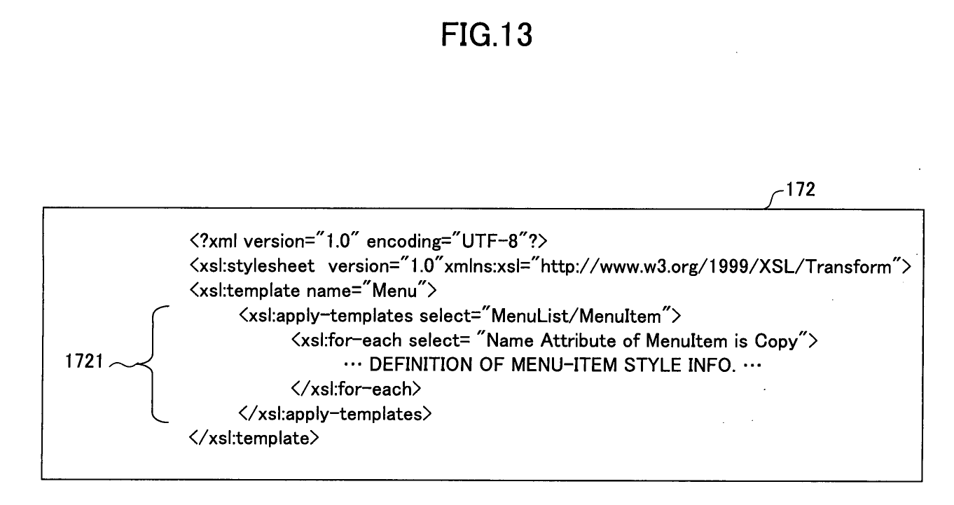

Furthermore, FIG. 13 shows an example of the definition of the dynamic menu-item XSL.

The description 1721 of dynamic menu-item XSL 172 shown in FIG. 13 is extracted according to the definition in the description 1711 of the extraction XSL 171 (FIG. 11) in the definition of the description 1921 which is the definition to the copy menu item in all-menu-item XSL 192 (FIG. 7).

Thus, the style information only over the menu item actually made applicable to the display is defined as the dynamic menu-item XSL 172.

Progressing to step S27 following step S26, the XSLT processor 105 outputs the created dynamic menu-item XSL 172 to the menu creation module 182 of the calling source.

At step S28, the menu creation module 182 outputs dynamic menu-item XSL 172 to the page creation module 181 of the calling source.

Progressing to step S29 following step S28, the page creation module 181 specifies the arguments of the dynamic menu-item XSL 172 which is received at step S28, and the all-menu-item XML 193, and calls the XSLT processor 105.

Progressing to step S30 following step S29, the XSLT processor 105 performs the XSL transform with the application of the dynamic menu-item XSL 172 to the all-menu-item XML 193, and creates the dynamic menu-item HTML which is the HTML data which is used to display the menu items in the document list page 500.

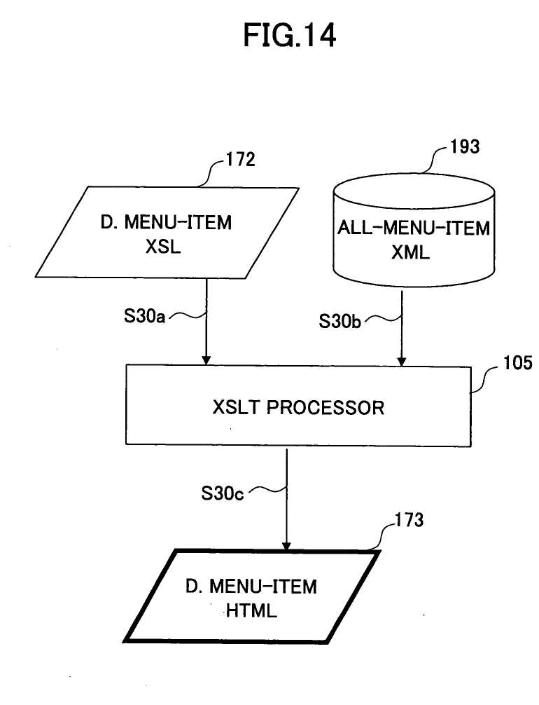

FIG. 14 shows the processing of the XSLT processor in the present embodiment to create the dynamic menu-item HTML.

As shown in FIG. 14, the XSLT processor 105 reads the dynamic menu-item XSL 172 and the all-menu-item XML 193 (S30a, S30b), and performs the XSL transform with the application of the dynamic menu-item XSL 172 to the all-menu-item XML 193 so that the dynamic menu-item HTML 173 is created (S30c).

In the dynamic menu-item HTML 173, the definition for displaying the menu items used for being displayed, and the definition concerning the processing performed when the menu items defined in the all-menu-item XML 193 are chosen are included according to the definition of the dynamic menu-item XSL 172.

In the present embodiment, the style information of only the copy menu item is defined in the dynamic menu-item XSL 172, and the definition for displaying the copy menu item and the .definition concerning the processing performed when the copy menu item is chosen is included in the dynamic menu-item HTML 173.

Progressing to step S31 following step S30, the XSLT processor 105 outputs the created dynamic menu-item HTML 173 to the page creation module 181.

Progressing to step S32 following step S31, the page creation module 181 performs other processing (for example, the acquisition of the document list information from the document managing server 30) required to create the document list page 500, merges the HTML data created based on the information acquired as the processing result, and the dynamic menu-item HTML 173, and creates a set of the HTML data (the document list page 500).

The document list page 500 which is created by the page creation module 181 is transmitted to the client 20 through the Web server program 101 (S33, S34), and it is displayed by the web browser 21 of the client 20.

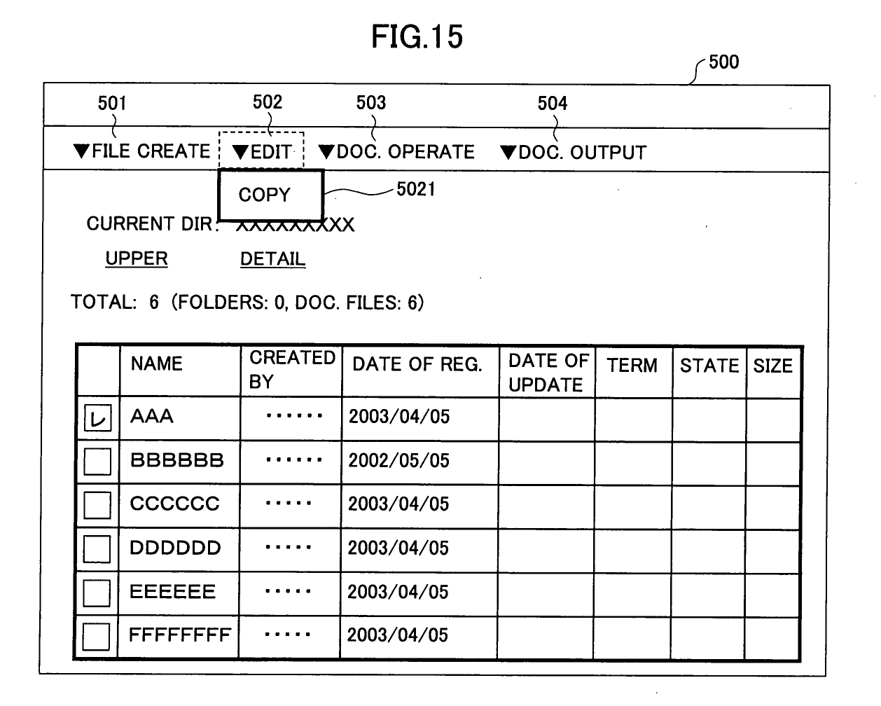

In the document list page 500 displayed by the web browser 21, if the edit menu 502 is clicked by the user, the menu items are displayed as shown in FIG. 15.

FIG. 15 shows an example of the display in which the menu items are customized for each user.

As shown in FIG. 15, in the document list page 500, the move menu item and the delete menu item are not displayed in the menu item 5021 of the edit menu 502, but only the copy menu item is displayed in the menu item 5021 of the edit menu 502. This is because the definition in the dynamic menu-item HTML 173, i.e., the definition for displaying only the copy menu item, is included for the menu item 5021 of the edit menu 502 in the source codes of the document list page 500.

In the above-described Web server 10 of the first preferred embodiment, the menu items are created according to the profile XML defined for each user, and it is possible to create the document list page 500 with which the menu items displayed on the computer are varied for each user.

Therefore, it is possible to display only the menu items which each user can use, and it is possible to prevent the occurrence of errors of the user's operation, and it is possible to increase the ease of operation for the user.

Moreover, the information about the menu items which cannot be used by the user is not included in the created Web page (the document list page 500), and it is possible to reduce the data size of the Web page, and it is possible to reduce the amount of the traffic between the client 20 and the Web server 10.

Moreover, the information concerning the necessity of the display of each menu item is managed with the profile XML 191 which is the data of XML format, according to the above-described embodiment. When compared with the conventional method in which the Web pages with which the different menu items for each user are defined are prepared in advance, it is possible for the above-described embodiment to make the handling, such as the changing of the setting (or the changing of the menu items being displayed), become easier.

In the above-described embodiment, the description of a single menu (the edit menu 502) has been given for the sake of convenience. However, the same processing can be applied to other menus in order to vary the menu items being displayed.

Moreover, in the above-described embodiment, the profile XML 191 is defined for every user. Alternatively, the definition of the profile XML may be classified according to a different category. For example, if the necessity of the display of the menu items is defined according to the kind of the terminal used (such as a PC, a PDA, a cellular phone, etc.), it is possible to create the Web page with which the menu items displayed on the terminal are varied dynamically according to the kind of each terminal.

Moreover, if the necessity of the display of the menu items is defined for each IP address of the terminals, it is possible to create. the Web page with which the menu items displayed on each terminal are varied dynamically according to each terminal.

In addition, the kind of each terminal and the IP address of each terminal can be easily identified using the information included in the HTTP request received from that terminal.

Next, a description will be given of the second preferred embodiment of the invention.

In the present embodiment, the document managing server 30a provides the function concerning the document DB 31 as the Web service and is equipped with the all-menu-item XML.

If the copy menu item, the move menu item and the delete menu item, belonging to the edit menu 502 of FIG. 4, are chosen, the selection of the menu items is notified to the Web server 10 and the command of execution of the processing corresponding to each item is transmitted in the SOAP format from the Web server 10 to the document managing server 30a.

The document managing server 30 performs the copying, the movement or the deletion processing of the document data in the document DB 31, according to the received command.

Therefore, whether the execution of the copying, movement or deletion processing of the document data is actually permitted or not varies with the situations of the document managing server 30a. For example, when only the processing of retrieval of the document data managed in the document DB 31 is permitted by the document managing server 30a, the movement or deletion processing of the document data is not permitted and the execution of such processing is impossible. In this case, if the menu items corresponding to the functions which cannot be performed by the document managing server 30a are not displayed, the displaying of the menu items other than the menu items inhibited is very useful for the user.

In the following, a description will be given of a case in which one server corresponds to one menu.(or the processing of all the menu items belonging to the one menu is performed by the same server), and the Web server 10 creates the Web page (the document list page 500) with which the menu items reflecting the situations of the server concerned are displayed.

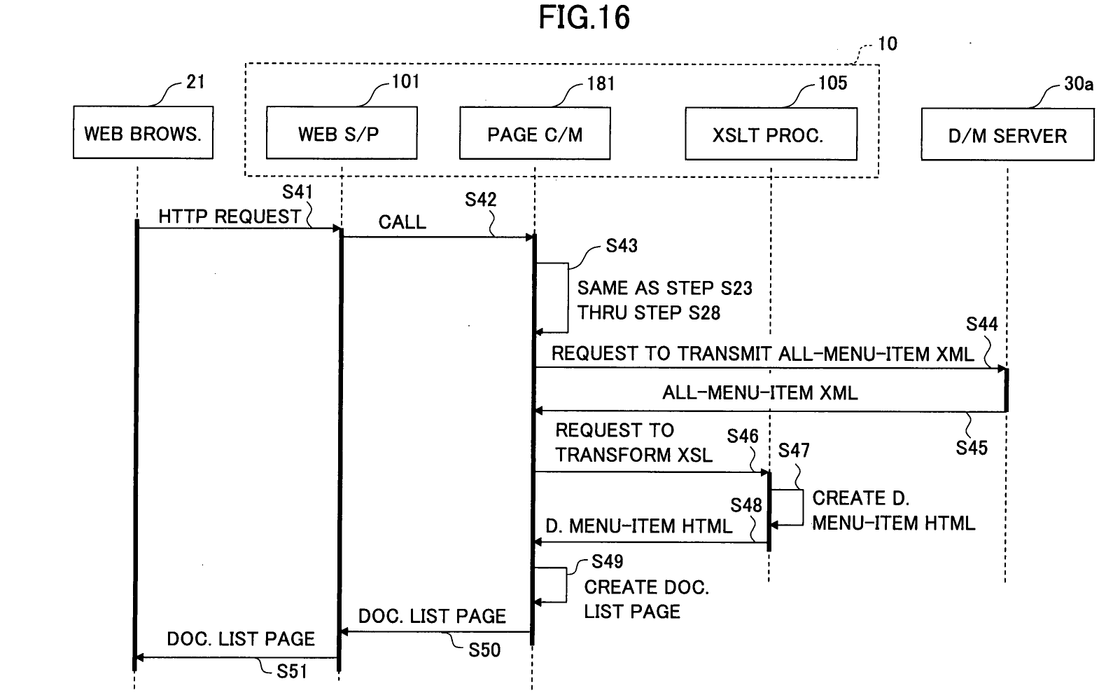

FIG. 16 is a sequence diagram for explaining the processing of the Web server in the second preferred embodiment of the invention.

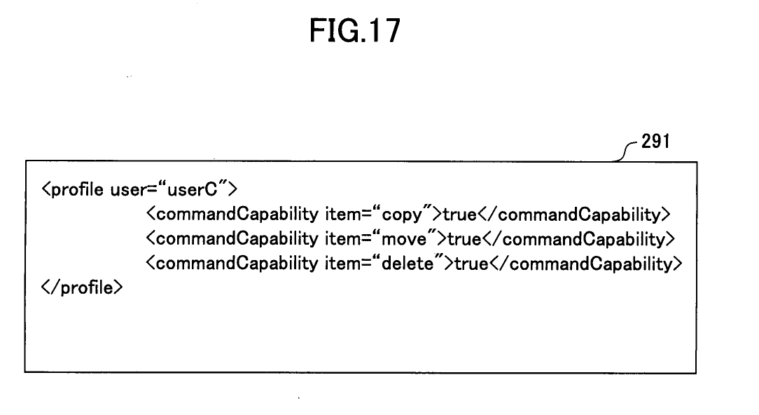

In FIG. 16, the steps S41 through S43 are essentially the same as corresponding steps S21 through S28 in FIG. 9, and a detailed description thereof will be omitted. Briefly, based on the HTTP request received from the web browser 21, the dynamic menu-item XSL is created according to the definition of the profile XML in the Web server 10. In the present embodiment, it is supposed that the profile XML to each user is defined as shown in FIG. 17.

FIG. 17 shows an example of the definition of the profile XML in the present embodiment.

As shown in FIG. 17, in the profile XML 291 to each user in the present embodiment, the setting in which all the menu items, including the copy, the move and the delete menu items, are the menu items being displayed (true) is defined.

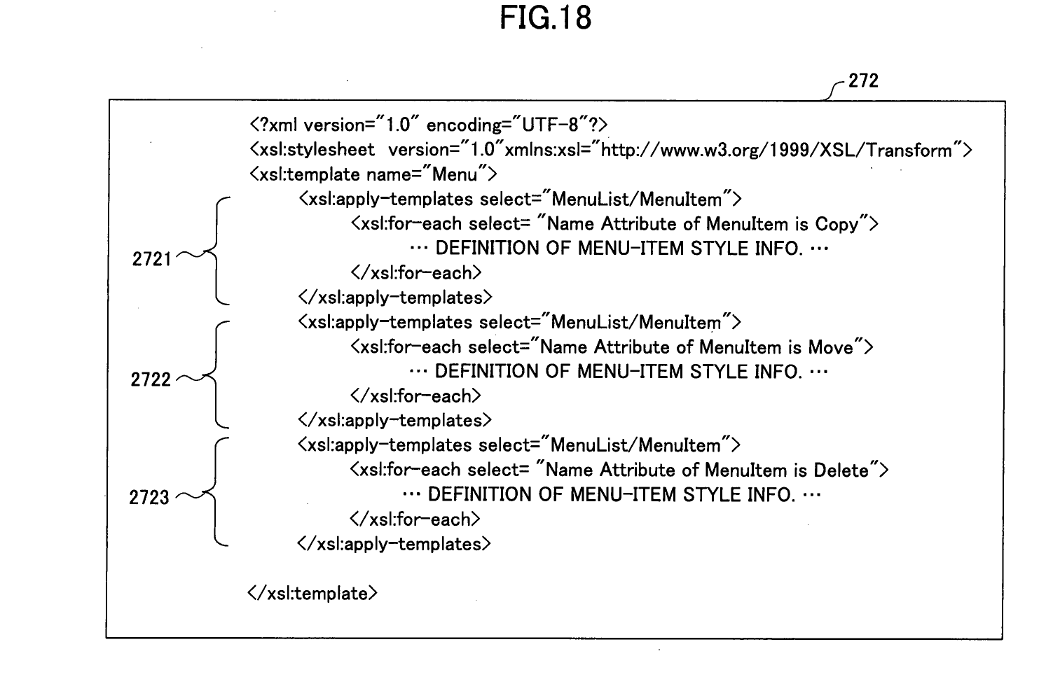

Therefore, the dynamic menu-item XSL which is created at step S43 in the processing of FIG. 16 is created as shown in FIG. 18.

FIG. 18 shows an example of the definition of the dynamic menu-item XSL in the present embodiment.

As shown in FIG. 18, in the dynamic menu-item XSL 272, the description 2721 includes the definition of the copy menu item, the description 2722 includes the definition of the move menu item, and the description 2723 includes the definition of the delete menu item, respectively.

Progressing to step S44, the page creation module 181 sends a request of transmission of the all-menu-item XML to the edit menu 502 in the SOAP format, to the document managing server 30a (SOAP request).

Progressing to step S45 following step S44, the document managing server 30a transmits the all-menu-item XML in which the definition of only about the menu items corresponding to the functions which can be performed by the document managing server 30a is included, to the page creation module 181 as a SOAP response to the SOAP request of the page creation module 181.

In this case, the all-menu-item XML which is transmitted by the document managing server 30a is created, in advance, corresponding to the functions which can be performed by the document managing server 30a, if the functions which can be performed are statically determined in the document managing server 30.

Moreover, if the functions which can be performed by the document managing server 30a vary dynamically in the document managing server 30 (for example, a case in which the deletion processing of document data is permitted at some time but the retrieval processing of the document data is possible at a certain time only), the all-menu-item XML may be created dynamically by the document managing server 30a.

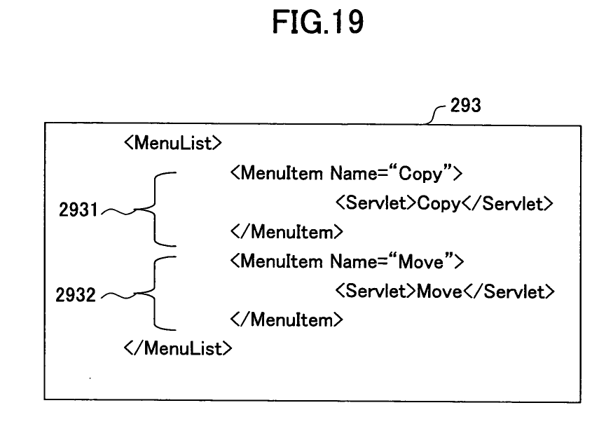

FIG. 19 shows an example of the definition of the all-menu-item XML acquired from the document managing server in the present embodiment.

As shown in FIG. 19, in the all-menu-item XML 293, the description 2931 includes the definition corresponding to the copy menu item, and the description 2932 includes the definition corresponding to the move menu item. Therefore, it is readily understood that, in the document managing server 30, the copying and movement processing of the document data is permitted, but the deletion processing of the document data is not permitted.

Progressing to step S46 following step S45, the page creation module 181 specifies the arguments of the dynamic menu-item XSL 272 and the all-menu-item XML 293 acquired from the document managing server 30, and calls the XSLT processor 105.

Progressing to step S47 following step S46, the XSLT processor 105 applies the dynamic menu-item XSL 272 to the all-menu-item XML 293, and creates the dynamic menu-item HTML which is the HTML data which is used to display the menu items in the document list page 500.

In addition, if the menu items the style information of which are defined in the dynamic menu-item XSL 272 are not defined in the all-menu-item XML 293, they are not the candidates for being outputted to the dynamic menu-item HTML. That is, in the second preferred embodiment, the definition about the menu items of the copy, the move and the delete is included in the dynamic menu-item XSL 272 (the descriptions 2721, 2722, and 2733), but the definition about the copy menu item and the move menu item only is included in the all-menu-item XML 293. Therefore, only the definition about the menu items of the copy and the move is outputted to the dynamic menu-item HTML.

The processing of step S48 and subsequent steps S49-51 in FIG. 16 is essentially the same as the processing of step S31 and subsequent steps S32-S34 in FIG. 9. Briefly, the page creation module 181 creates the document list page 500 using the dynamic menu-item HTML created by the XSLT processor 105 (S49). The document list page 500 is transmitted from the Web server 10 to the client 20 (S50, S51), so that the document list page 500 is displayed by the web browser 21.

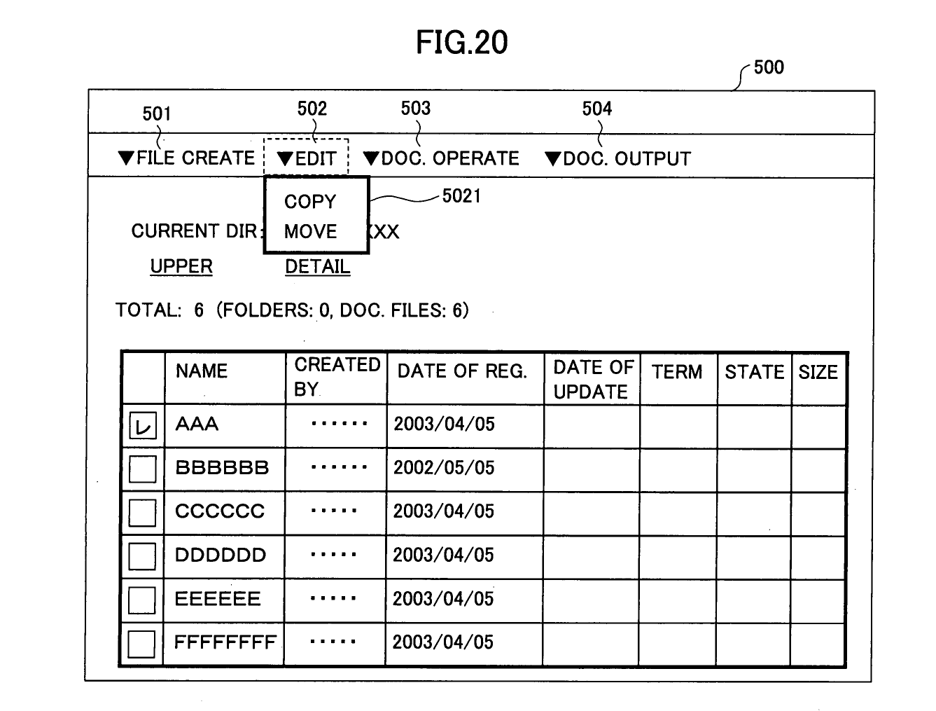

When the user clicks the edit menu 502 in the document list page 500 displayed by the web browser 21, the menu items are displayed as shown in FIG. 20.

FIG. 20 shows an example of the display of the menu items in the present embodiment. As shown in FIG. 20, in the document list page 500, the delete menu item is not displayed in the menu item 5021 of the edit menu 502, and only the copy menu item and the move menu item are displayed therein.

Accordingly, the user can recognize that the setting indicate that the user cannot perform the deletion of document data.

As described above, according to the Web server 10 of the second preferred embodiment, in addition to the advantages of the Web server 10 of the first preferred embodiment, it is possible to create the Web page which is arranged to reflect the situations in the server (the document list server 30a) corresponding to the menu, and the menu items are displayed with the Web page.

Therefore, the user does not choose the menu item which cannot be performed primarily and it is possible to prevent the occurrence of useless operation.

Next, a description will be given of the third preferred embodiment of the invention.

In the present embodiment, by sending an inquiry about the state of the print server 40, the fax server 50, and the delivery server 60, which provide the respective functions as the Web service, and the menu items being displayed on the computer screen is varied dynamically according to the answer to the inquiry.

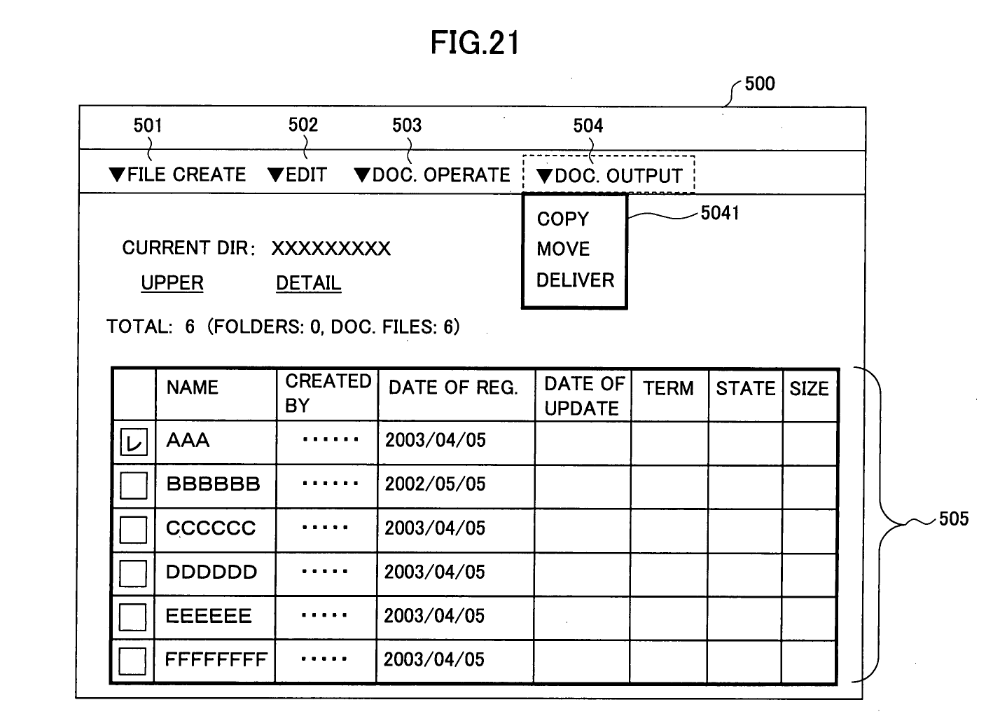

FIG. 21 shows an example of the display of the menu items belonging to the document output menu in the present embodiment. As shown in FIG. 21, the print menu item, the fax menu item, and the delivery menu item are included in the menu-item list 5041 belonging to the document output menu 504.

The print menu item is the menu item chosen when the document data chosen in the document list 505 is printed. The fax menu item is the menu item chosen when the fax transmission of the document data chosen in the document list 505 is carried out. The delivery menu item is the menu item chosen when the document data chosen in the document list 505 is delivered to the prescribed user.

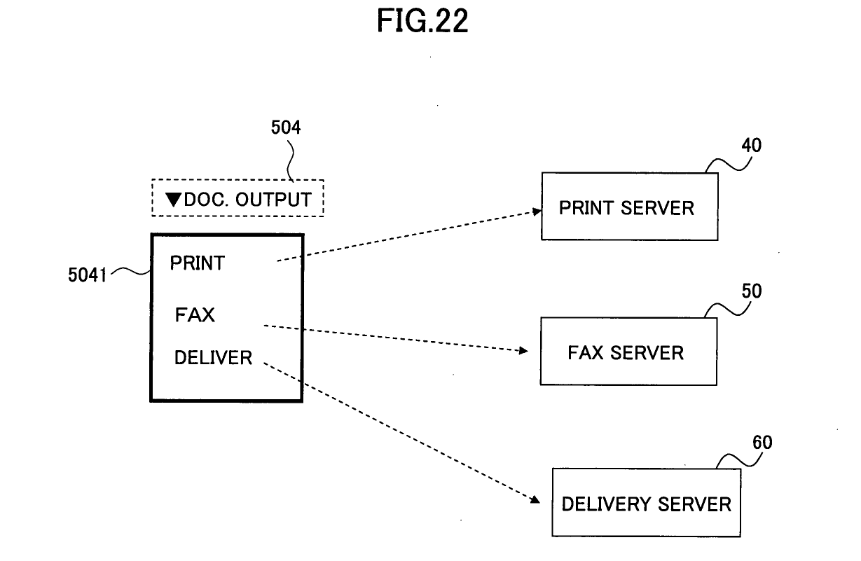

When the above-mentioned three menu items are chosen, the servers which perform the processing concerned are different from each other. FIG. 22 is a diagram for explaining a correspondence of the menu items and the respective servers in the present embodiment. As shown in FIG. 22, the print server 40, the fax server 50, and the delivery server 60 correspond to the print menu item, the fax menu item, and the delivery menu item, respectively.

That is, when the print menu item is chosen, the Web server 10 causes the print server 40 to perform printing processing of the document data by performing the SOAP call of the document printing method mounted in the print server 40. Similarly, when the delivery menu item is chosen, the Web server 10 causes the delivery server 60 to perform the delivery of the document data by carrying out the SOAP call of the delivery method mounted in the delivery server 60. When the fax menu item is chosen, the Web server 10 causes the fax server 50 to perform the fax transmission of the document data by carrying out the SOAP call of the fax transmitting method mounted in the fax server 50.

Therefore, whether the function corresponding to each menu item can be used depends on the state of the server corresponding to the function concerned. For example, when the print server 40 is in a state that the communication is impossible or when the printer 41 linked to the print server 40 is powered down, the print menu cannot be used even if it is displayed.

If the print menu item is not displayed in such a case, the user can recognize, prior to instructing the printing, that the printing function cannot be used, which is very useful for the user.

In the following, a description will be given of the third preferred embodiment in which the servers corresponding to the respective menu items are different from each other, and the Web server 10 creates the Web page (the document list page 500) with which the menu items reflecting the state of each server are displayed.

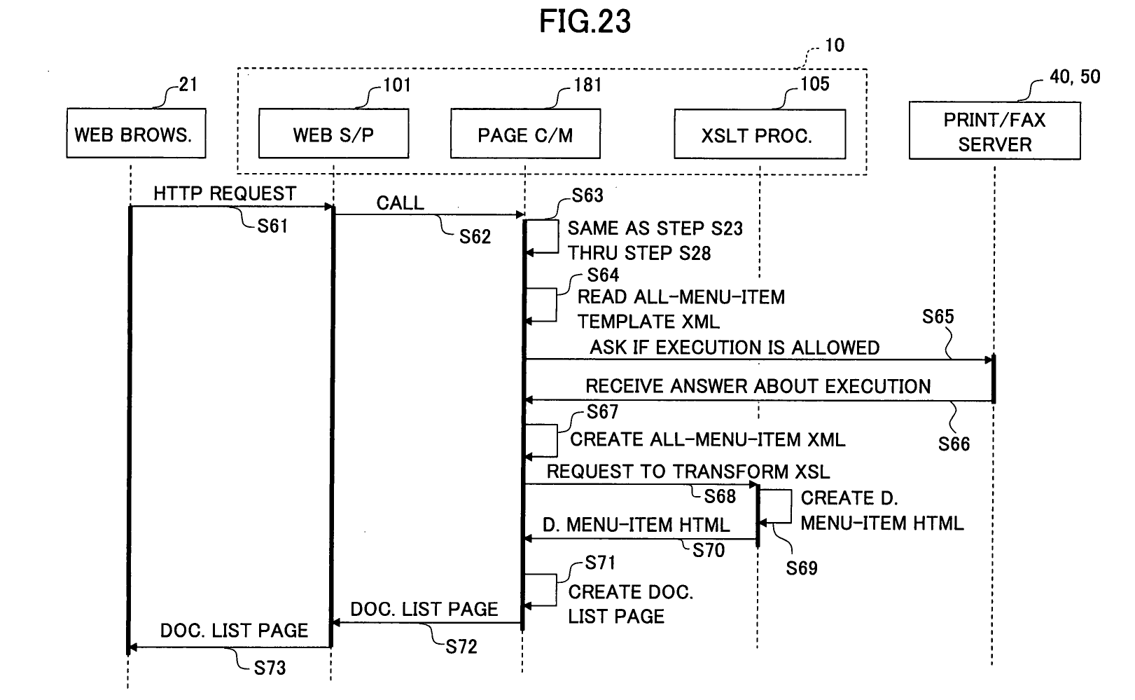

FIG. 23 is a sequence diagram for explaining the processing performed by the Web server in the present embodiment.

The processing of steps S61 to S63 in FIG. 23 is essentially the same as that of steps S21 to S28 in FIG. 9. Briefly, the Web server 10 receives the HTTP request from the web browser 21 and creates the dynamic menu-item XSL (S61-S63).

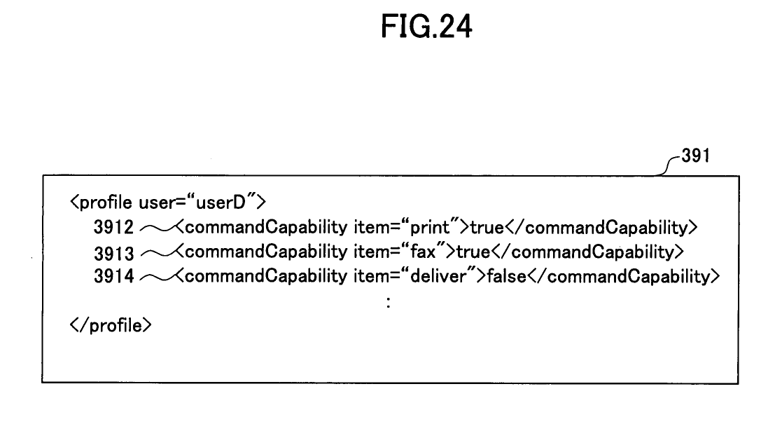

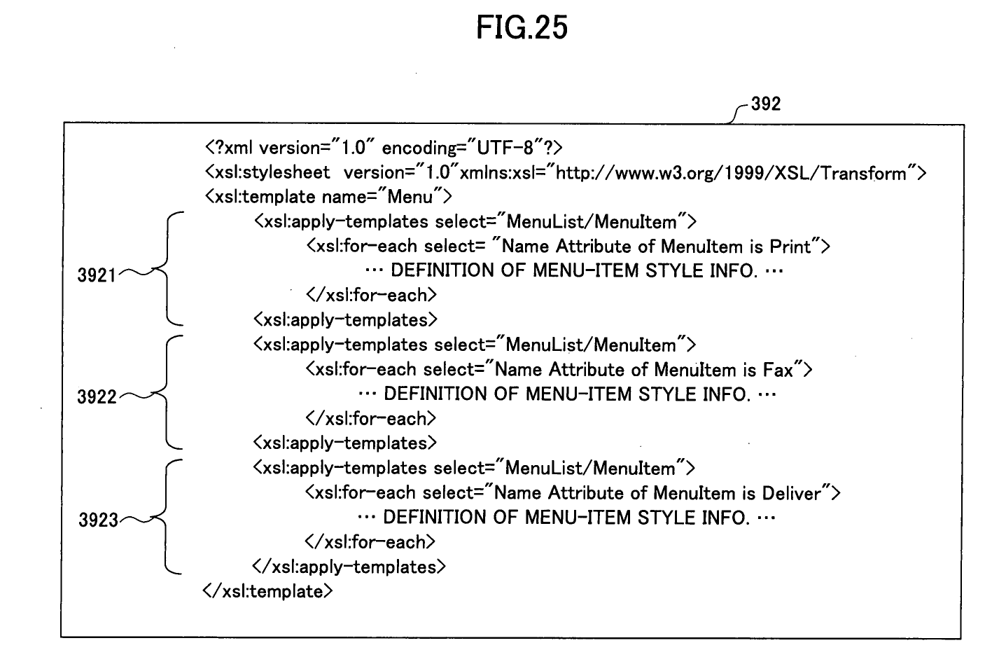

In the present embodiment, an example of the definition of the profile XML and an example of the definition of the all-menu-item XSL are as shown in FIG. 24 and FIG. 25, respectively.

FIG. 24 shows an example of the definition of the profile XML in the present embodiment. As shown in FIG. 24, in the description 3912 and the description 3913 of the profile XML 391, the setting indicating that the print menu item and the fax menu item are applicable to the display is defined, respectively. Moreover, in the description 3914, the setting indicating that the delivery menu item is not applicable to the display is defined.

FIG. 25 shows an example of the definition of the all-menu-item XSL in the present embodiment. As shown in FIG. 25, in the description 3921, the description 3922 and the description 3923 of the all-menu-item XSL 392, the style information of the print menu item, the fax menu item and the delivery menu item is defined, respectively.

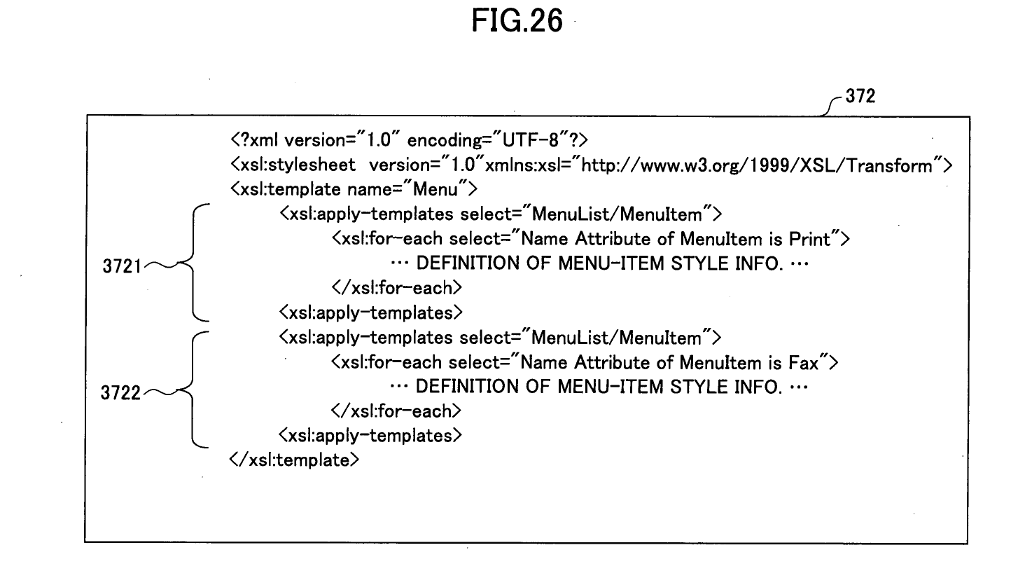

Therefore, in the processing of step S63, the dynamic menu-item XSL is created as shown in FIG. 26.

FIG. 26 shows an example of the definition of the dynamic menu-item XSL in the present embodiment. As shown in FIG. 26, the description 3721 and the description 3722 in the dynamic menu-item XSL 372 are the results of extraction of the description 3921 and the description 3922 from the all-menu-item XSL 392, respectively.

Since the delivery menu item is not defined as the candidate for the display in the profile XML 391 as mentioned above, the description 3923 in the all-menu-item XSL 392, which is the definition corresponding to the delivery menu item, is not outputted to the dynamic menu-item XSL 372 as shown in FIG. 26.

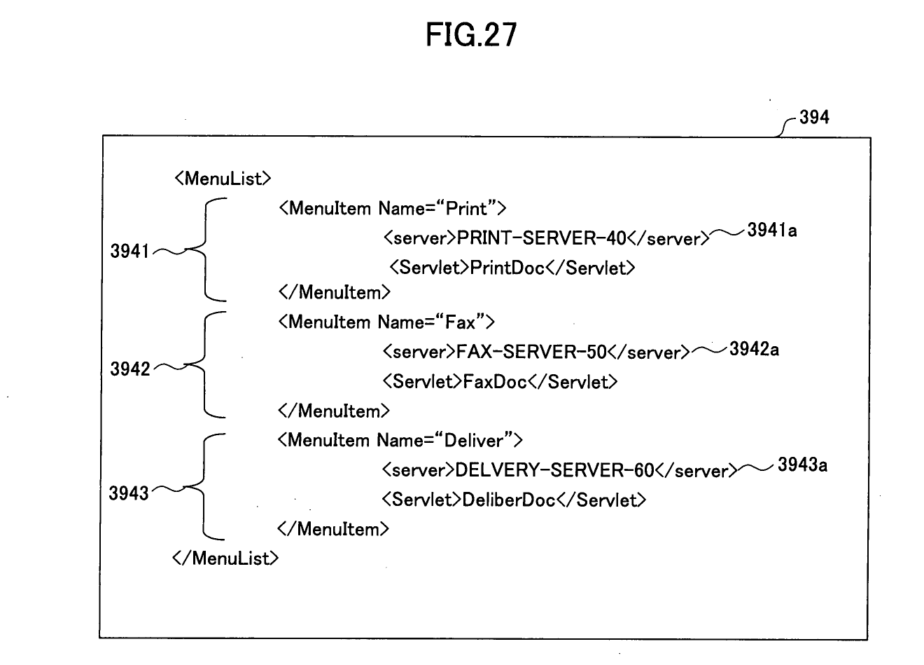

Progressing to step S64 following step S63, the page creation module 181 reads the all-menu-item template XML stored in advance. The all-menu-item template XML is the data of XML format which is used as the form of the all-menu-item XML, and an example of the definition of the all-menu-item template XML is shown in FIG. 27.

FIG. 27 shows an example of the definition of the all-menu-item template XML in the present embodiment. As shown in FIG. 27, the all-menu-item template XML 394 has the almost same composition as the all-menu-item XML 193 and the all-menu-item XML 293, which are used in the previous embodiments, in that the predetermined information for each menu item is registered. However, the information for identifying the server which performs the processing corresponding to the menu item (which is surrounded by the server tag) is further registered in the all-menu-item template XML 394, in addition to the information which identifies the processing which should be performed for each menu item as being registered in the all-menu-item XML 193.

That is, the host name of the print server 40, the fax server 50, and the delivery server 60 is registered in the description 3941a, the description 3942a and the description 3943a of the all-menu-item template XML 394, respectively. In addition, the host names may be the mere examples. Alternatively, the IP address or the information for identifying each server on the network 70 may be used instead.

Progressing to step S65 following step S64, the page creation module 181 determines the server corresponding to each menu item based on the description 3941a and the description 3942a of the all-menu-item template XML 394. The page creation module 181 sends an inquiry about the allowability of the execution of the processing to each server (the print server 40, the fax server 50).

In addition, the delivery server 60 is specified by the profile XML 391 that the delivery menu item is not the candidate for the display, the inquiry of the state of the delivery server is not sent.

Progressing to step S66 following step S65, the response to the inquiry of the state of each server is transmitted from the respective servers to the page creation module 181.

It is supposed that the printer 41 is powered down, and the print server 40 transmits the response that the printing function cannot be used, and the fax server 50 transmits the response that the fax transmission function can be used.

Progressing to step S67 following step S66, based on the response from each server, the page creation module 181 extracts the descriptions corresponding to only the menu items which can be used, from the all-menu-item template XML 394, and creates the resulting all-menu-item XML. In this example, the description corresponding to the fax menu item only is outputted to the all-menu-item XML.

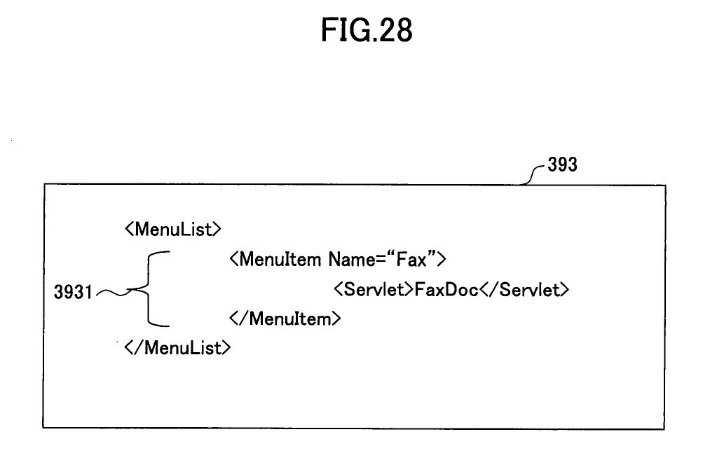

FIG. 28 shows an example of the definition of the all-menu-item XML created by the Web server in the present embodiment. As shown in FIG. 28, in the all-menu-item XML 393, the description 3931 includes the definition corresponding to the fax menu item extracted from the all-menu-item template XML 394.

The processing of steps S68 to S73 is essentially the same as the processing of steps S46 to S51 of FIG. 16 in the second preferred embodiment. Briefly, the XSLT processor 105 creates the dynamic menu-item HTML by performing the XSL transform with the application of the dynamic menu-item XSL 372 to the all-menu-item template XML 394 (S68-S70). Moreover, the page creation module 181 creates the document list page 500 containing the dynamic menu-item HTML (S71). The document list page 500 is transmitted to the client 20 so that the document list page 500 is displayed by the web browser 21 (S72, S73).

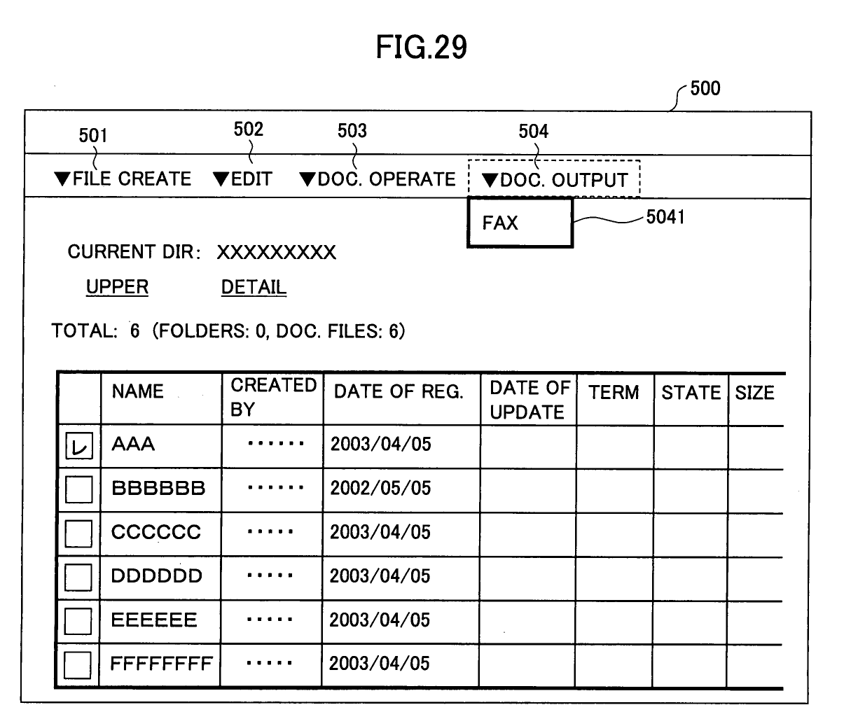

When the user clicks the document output menu 504 in the document list page 500 displayed by the web browser 21, the menu item of the document output menu 504 is displayed as shown in FIG. 29.

FIG. 29 shows an example of the display of the menu items in the present embodiment. As shown in FIG. 29, in the document list page 500, only the fax menu item is displayed on the menu-item list 5041 of the document output menu 504. The print menu item is not displayed because the printing processing cannot be performed by the print server 40. The delivery menu item is not displayed because the setting indicating that the displaying of the delivery menu item is unnecessary is defined in the profile XML 391.

According to the above-described Web server 10 of the third preferred embodiment, it is possible to create the Web page which is arranged to reflect the state of the server corresponding to each menu item and display such menu items, in addition to the advantages of the Web server 10 of the first preferred embodiment.

Therefore, the user does not choose the menu item which cannot be performed primarily, and it is possible to prevent the occurrence of useless operation.

In addition, the Web server 10 does not necessarily need to have the all-menu-item template XML 394 in the third preferred embodiment. For example, it is possible that a predetermined server, which is connected through the network 70, is provided to manage the all-menu-item template XML 394. In such a case, it is possible that the same all-menu-item template is shared by two or more Web servers and the increase of the storage capacity in the Web server 10 is avoided.

Moreover, in the above-mentioned embodiments, the setting of true or false is used for each menu item as the information indicating the necessity of the display of the menu item in the profile XML 191, the profile XML 291 or the profile XML 391.

Alternatively, it is possible to set the definition of only the menu items the displaying of which is unnecessary in the profile XML. Namely, only the setting of false may be used for each menu item. In such alternative embodiment, what is necessary is just to create the Web page such that the menu items other than the menu items the displaying of which is unnecessary are defined in the profile XML, may be displayed. That is, the style information of the menu items other than the menu items defined in the profile XML concerned is extracted from the all-menu-item XSL, and the definition of the extraction XSL is created based on the profile XML.

In such alternative embodiment, maintenance work can be done easily when add a new menu item for all the users. That is, if the definition corresponding to the new menu item concerned is added to the all-menu-item XML and the all-menu-item XSL, the new menu item concerned will be displayed for all the users, unless the setting indicating that the displaying of the new menu item concerned is unnecessary is defined in the profile XML of each user.

On the contrary to the above, it is possible to set the definition of only the menu items the displaying of which is necessary in the profile XML. Namely, only the setting of true may be used for each menu item. In such alternative embodiment, what is necessary is just to create the Web page such that only the menu items defined in the profile XML as being displayed are displayed. In this manner, the reflecting effects to the above-mentioned case can be acquired.

That is, when the definition to the new menu item is added to the all-menu-item XML and the all-menu-item XSL, it can prevent that the use of the new menu item concerned is unconditionally attained for all the users. This is because the new menu item concerned is not displayed unless the definition to the new menu item concerned is added in the profile XML of each user.

Moreover, when the definition of the setting of true only is carried out, it is possible to create the dynamic menu-item XSL directly based on the profile XML. That is, the dynamic menu-item XSL is because it can draw directly which menu item should be made applicable to the display based on the profile XML when only the definition concerning true is carried out the place which is what the style information over the operation item made applicable to the display should be defined. Therefore, the creation of the extraction XSL may be unnecessary and the processing efficiency of the Web page creation can be raised.

In recent years, various devices which are specialized in a certain specific function are provided with the Web server function and the network communicating function, and such devices are capable of performing information processing equivalent to a personal computer.

For example, an image forming apparatus having a plurality of application programs which perform the processing specific to the multiple services, including the printer, the copier and the facsimile functions, is provided, which is called the multi-function peripheral system.

Some of the recent image forming apparatuses are provided with the Web server function and the document-management function. By using the document-management function, the copied information or the information of the received facsimile data can be accumulated and managed as the document data.

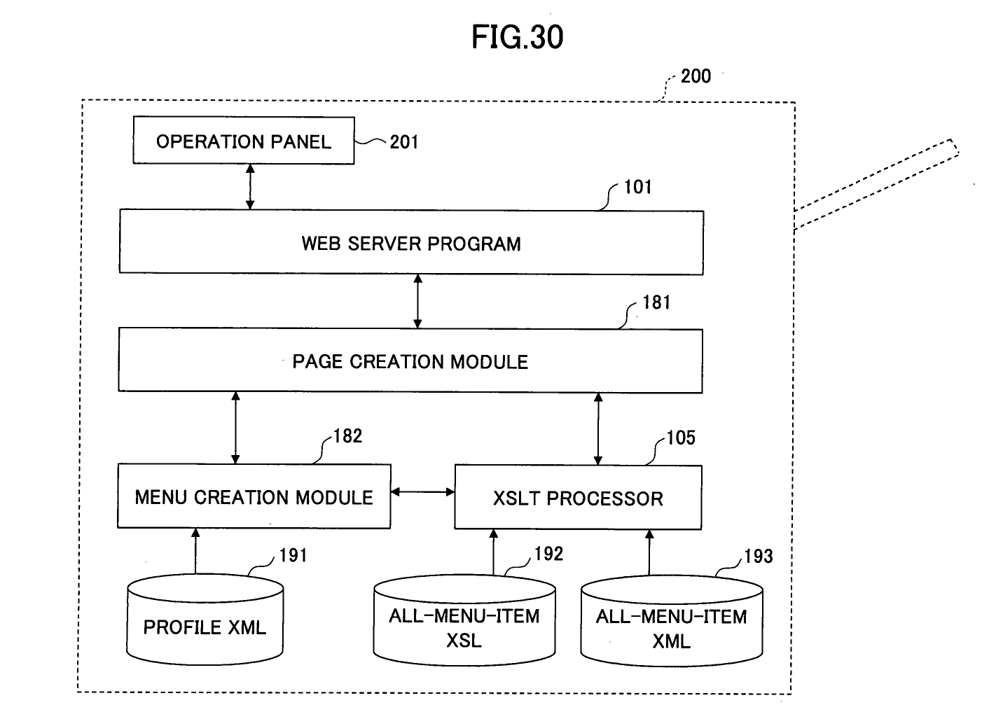

Therefore, it is possible to incorporate the Web page creation function, which is incorporated in the Web server 10 in the above-described embodiments, into such image forming apparatus (or the multi-function peripheral system). FIG. 30 shows an image forming apparatus which is provided with the Web page creation function of the present invention.

In FIG. 30, the elements which are essentially the same as corresponding elements in FIG. 5 are designated by the same reference numerals, and a description thereof will be omitted.

In the image forming apparatus 200 of FIG. 30, the operation panel 201 is the panel which provides the user interface for allowing the user to operate the image forming apparatus 200.

The operation panel 201 has the web browser function. The operation panel can send a request of acquisition of the Web page to the Web server program 101 based on the input by the user, and can display the Web page outputted by the Web server program 101 as the response to the request concerned.

Therefore, the software of the image forming apparatus 200 is configured to have the composition as shown in FIG. 30, and using the page creation module 181, the menu creation module 182, and the XSLT processor 105, the image forming apparatus 200 can create the Web page in the same logic as the Web server 10. It is possible for the image forming apparatus 200 to dynamically vary the menu items of the Web page displayed on the operation panel 201 according to the predetermined user conditions or other conditions.

In addition, the information displayed on the Web page concerned may be provided to include not only the information concerning the printer function, the copier function, the fax function and the document-management function, mounted in the image forming apparatus 200, but also the information acquired through the network by the page creation module 181 as in the Web server 10.

As for the above-mentioned embodiments, the operation-item display information in the claims corresponds to the information contained in the profile XML, the Web page creation unit in the claims corresponds to the page creation module 181, the menu creation module 182 and the XSLT processor 105, the first style information in the claims corresponds to the dynamic operation-item XSL, the operation-item style information creation unit in the claims corresponds to the menu creation module 182, the operation-item creation unit in the claims corresponds to the XSLT processor 105, the second style information management unit in the claims corresponds to the all-menu-item XSL, the third style information in the claims corresponds to the extraction XSL, the third style information creation unit in the claims corresponds to the step S24 of FIG. 9, the processing identification data management unit in the claims corresponds to the all-menu-item XML, the request receiving unit and the Web page transmitting unit in the claims correspond to the Web server program 101, the inquiry unit in the claims corresponds to the step S44 of FIG. 16, and the permitted-function inquiry unit in the claims corresponds to the step S65 of FIG. 23.

The present invention is not limited to the above-described specific embodiments, and variations and modifications may be made without departing from the scope of the present invention.

Further, the present application is based on Japanese priority application No. 2003-098112, filed on Apr. 1, 2003, and Japanese priority application No. 2004-074962, filed on Mar. 16, 2004, the entire contents of which are hereby incorporated by reference.

What is claimed is:

1. A Web page creation apparatus comprising:
a Web page creation unit creating a Web page having operation items, the Web page creation unit creating the Web page based on operation-item display information, which is defined for a device where the Web page is displayed or a user of the device to indicate whether the displaying of each operation item is needed, so that some of the operation items the displaying of which is needed are displayed.

2. The Web page creation apparatus according to claim 1 wherein the Web page creation unit comprises:
an operation-item style information creation unit creating first style information for each of the operation items the displaying of which is needed, based on the operation-item display information; and
an operation-item creation unit creating the operation items in the Web page according to the first style information created by the operation-item style information creation unit.

3. The Web page creation apparatus according to claim 2 wherein the operation-item style information creation unit is provided to create the first style-information by making reference to the operation-item display information.

4. The Web page creation apparatus according to claim 2 wherein the first style information is a data of XSL format.

5. The Web page creation apparatus according to claim 2 further comprising a second style information management unit managing second style information for all the operation items that can be displayed in the Web page, wherein the operation-item style information creation unit is provided to create the first style information by extracting style information corresponding to each of the operation items the displaying of which is needed by the operation-item display information, from the second style information managed by the second style information management unit.

6. The Web page creation apparatus according to claim 5 wherein the second style information is a data of XSL format.

7. The Web page creation apparatus according to claim 5 wherein the operation-item style information creation unit comprises a third style information creation unit creating third style information, which is used to extract the style information corresponding to each of the operation items the displaying of which is needed by the operation-item display information, from the second style information, and the operation-item style information creation unit is provided to create the first style information by applying the third style information, created by the third style information creation unit, to the second style information.

8. The Web page creation apparatus according to claim 7 wherein the third style information is a data of XSL format.

9. The Web page creation apparatus according to claim 2 further comprising a processing identification data management unit managing processing identification information for identifying processing to be performed when one of the operation items is chosen, wherein the operation-item creation unit is provided to create each of the operation items by applying the first style information to the processing identification information managed by the processing identification data management unit, so that the processing identified by the processing identification information corresponding to the chosen operation item is performed.

10. The Web page creation apparatus according to claim 1 further comprising:
a request receiving unit receiving a request of acquisition of the Web page from the device and causing the Web page creation unit to create the Web page based on the request of acquisition of the Web page; and
a Web page transmitting unit transmitting the Web page, created by the Web page creation unit, to the device.

11. A Web page creation apparatus comprising:
a Web page creation unit creating a Web page having operation items corresponding to functions of an external device; and
an inquiry unit transmitting an inquiry about usable functions of the external device to the external device,
wherein the Web page creation unit creates the Web page based on both operation-item display information, which is defined for a device where the Web page is displayed or a user of the device to indicate whether displaying of each operation item is needed, and usable function identification information, which is received from the external device in response to the inquiry of the inquiry unit and indicates the usable functions of the external device, so that the operation items corresponding to the usable functions of the external device are displayed.

12. The Web page creation apparatus according to claim 11 wherein the Web page creation unit is provided to create the Web page so that the operation items corresponding to the usable functions of the external device indicated by the usable function identification information, among the operation items the displaying of which is needed by the operation-item display information, are displayed.

13. The Web page creation apparatus according to claim 11 wherein the Web page creation unit comprises:
an operation-item style information creation unit creating first style information for each of the operation items the displaying of which is needed, based on the operation-item display information; and
an operation-item creation unit creating the operation items in the Web page by applying the first style information created by the operation-item style information creation unit, to the usable function identification information.

14. The Web page creation apparatus according to claim 13 wherein the operation-item style information creation unit is provided to create the first style information by making reference to the operation-item display information.

15. The Web page creation apparatus according to claim 13 wherein the first style information is a data of XSL format.

16. The Web page creation apparatus according to claim 13 further comprising a second style information management unit managing second style information for all the operation items that can be displayed in the Web page, wherein the operation-item style information creation unit is provided to create the first style information by extracting style information corresponding to each of the operation items the displaying of which is needed by the operation-item display information, from the second style information managed by the second style information management unit.

17. The Web page creation apparatus according to claim 16 wherein the second style information is a data of XSL format.

18. The Web page creation apparatus according to claim 16 wherein the operation-item style information creation unit comprises a third style information creation unit creating third style information, which is used to extract the style information corresponding to each of the operation items the displaying of which is needed by the operation-item display information, from the second style information, and the operation-item style information creation unit is provided to create the first style information by applying the third style information, created by the third style information creation unit, to the second style information.

19. The Web page creation apparatus according to claim 18 wherein the third style information is a data of XSL format.

20. The Web page creation apparatus according to claim 13 wherein the operation-item creation unit is provided to create each of the operation items by applying the first style information to the usable function identification information, so that processing, concerning the function identified by the usable function identification information corresponding to the operation item concerned, is performed when one of the operation items is chosen.

21. The Web page creation apparatus according to claim 11 further comprising:
a request receiving unit receiving a request of acquisition of the Web page from the device and causing the Web page creation unit to create the Web page based on the request of acquisition of the Web page; and
a Web page transmitting unit transmitting the Web page, created by the Web page creation unit, to the device.

22. The Web page creation apparatus according to claim 11 wherein the inquiry unit is provided to transmit the inquiry about the usable functions to the external device in accordance with SOAP.

23. A Web page creation apparatus comprising:
a Web page creation unit creating a Web page having operation items corresponding to functions of different external devices respectively; and
a permitted-function inquiry unit transmitting an inquiry about allowability of execution of a corresponding one of the functions for one of the operation items, to each of the external devices,
wherein the Web page creation unit creates the Web page based on both operation-item display information, which is defined for a device where the Web page is displayed or a user of the device to indicate whether displaying of each operation item is needed, and permitted-function identification information, which is received from the external devices in response to the inquiry of the permitted-function inquiry unit and indicates the allowability of execution of each of the functions, so that the operation items corresponding to the permitted functions of the external devices are displayed.

24. The Web page creation apparatus according to claim 23 wherein the Web page creation unit is provided to create the Web page so that the operation items corresponding to the permitted functions of the external devices indicated by the permitted-function identification information, among the operation items the displaying of which is needed by the operation-item display information, are displayed.

25. The Web page creation apparatus according to claim 23 wherein the Web page creation unit comprises:
an operation-item style information creation unit creating first style information for each of the operation items the displaying of which is needed, based on the operation-item display information; and
an operation-item creation unit creating the operation items in the Web page by applying the first style information created by the operation-item style information creation unit, to the permitted-function identification information.

26. The Web page creation apparatus according to claim 25 wherein the operation-item style information creation unit is provided to create the first style information by making reference to the operation-item display information.

27. The Web page creation apparatus according to claim 25 wherein the first style information is a data of XSL format.

28. The Web page creation apparatus according to claim 25 further comprising a second style information management unit managing second style information for all the operation items that can be displayed in the Web page, wherein the operation-item style information creation unit is provided to create the first style information by extracting style information corresponding to each of the operation items the displaying of which is needed by the operation-item display information, from the second style information managed by the second style information management unit.

29. The Web page creation apparatus according to claim 28 wherein the second style information is a data of XSL format.

30. The Web page creation apparatus according to claim 28 wherein the operation-item style information creation unit comprises a third style information creation unit creating third style information, which is used to extract the style information corresponding to each of the operation items the displaying of which is needed by the operation-item display information, from the second style information, and the operation-item style information creation unit is provided to create the first style information by applying the third style information, created by the third style information creation unit, to the second style information.

31. The Web page creation apparatus according to claim 30 wherein the third style information is a data of XSL format.

32. The Web page creation apparatus according to claim 25 further comprising a function identification data management unit managing function identification information for identifying a corresponding one of the functions for one of the operation items wherein the operation-item creation unit is provided to create each of the operation items by applying the first style information to the function identification information, so that, when one of the operation items is chosen, processing concerning the function identified by the function identification information corresponding to the chosen operation item is performed.

33. The Web page creation apparatus according to claim 32 wherein the Web page creation unit is provided to create extraction function identification information by extracting the function identification information, corresponding to the functions the allowability of execution of which is indicated by the permitted-function identification information, from the function identification data management unit, and the operation-item creation unit creates the operation items by applying the first style information to the extraction function identification information.

34. The Web page creation apparatus according to claim 32 wherein the function identification data management unit further manages external-device identification information which identifies one of the external devices used as a location to which the inquiry about the allowability of execution of the corresponding function for one of the operation items is transmitted, and the permitted-function inquiry unit determines said one of the external devices based on the external-device identification information.

35. The Web page creation apparatus according to claim 23 further comprising:
a request receiving unit receiving a request of acquisition of the Web page from a device and causing the Web page creation unit to create the Web page based on the request of acquisition of the Web page; and
a Web page transmitting unit transmitting the Web page, created by the Web page creation unit, to the device.

36. The Web page creation apparatus according to claim 23 wherein the permitted-function inquiry unit is provided to transmit the inquiry about the allowability of execution of the corresponding function for one of the operation items to each external device in accordance with SOAP.

37. A method of controlling Web page creation in a Web page creation apparatus which creates a Web page having operation items, comprising steps of:
creating first style information for each of the operation items displaying of which is needed, based on operation-item display information which is defined for a device on which the Web page is displayed or a user of the device to indicate whether the displaying of each operation item is needed; and
creating the operation items in the Web page according to the first style information created in the first creating step, so that some of the operation items the displaying of which is needed are displayed.

38. The method according to claim 37 wherein the first creating step is provided to create the first style information by extracting style information corresponding to each of the operation items the displaying of which is needed by the operation-item display information, from second style information for all the operation items that can be displayed in the Web page.

39. The method according to claim 38 wherein the first creating step includes a step of creating third style information, which is used to extract the style information corresponding to each of the operation items the displaying of which is needed by the operation-item display information, from the second style information, and the first creating step is provided to create the first style information by applying the third style information created in the third creating step, to the second style information.

40. The method according to claim 37 wherein the second creating step is provided to create each of the operation items by applying the first style information to processing identification information for identifying processing to be performed when one of the operation items is chosen, so that the processing identified by the processing identification information corresponding to the chosen operation item is performed.

41. A method of controlling Web page creation in a Web page creation apparatus which creates a Web page having operation items corresponding to functions of an external device, comprising steps of:
transmitting an inquiry about usable functions of the external device to the external device,
creating the Web page based on both operation-item display information, which is defined for a device where the Web page is displayed or a user of the device to indicate whether displaying of each operation item is needed, and usable function identification information, which is received from the external device in response to the inquiry and indicates the usable functions of the external device, so that the operation items corresponding to the usable functions of the external device are displayed.

42. The method according to claim 41 wherein the creating step includes:
creating first style information for each of the operation items the displaying of which is needed, based on the operation-item display information; and
creating the operation items in the Web page by applying the first style information created in the first style information creating step, to the usable function identification information.

43. The method according to claim 42 wherein the first style information creating step is provided to create the first style information by extracting style information corresponding to each of the operation items the displaying of which is needed by the operation-item display information, from second style information for all the operation items that can be displayed in the Web page.

44. The method according to claim 43 wherein the first style information creating step is provided to create the first style information by applying third style information, which is used to extract the style information corresponding to each of the operation items the displaying of which is needed by the operation-item display information, from the second style information, to the second style information.

45. A method of controlling Web page creation in a Web page creation apparatus which creates a Web page having operation items corresponding to functions of different external devices respectively, comprising steps of:
transmitting an inquiry about allowability of execution of a corresponding one of the functions for one of the operation items, to each of the external devices; and
creating the Web page based on both operation-item display information, which is defined for a device where the Web page is displayed or a user of the device to indicate whether displaying of each operation item is needed, and permitted-function identification information, which is received from the external devices in response to the inquiry and indicates the allowability of execution of each of the functions, so that the operation items corresponding to the permitted functions of the external devices are displayed.

46. The method according to claim 45 wherein the Web page creating step includes:
creating first style information for each of the operation items the displaying of which is needed, based on the operation-item display information; and
creating the operation items in the Web page by applying the created first style information to the permitted-function identification information.

47. The method according to claim 46 wherein the first style information is created by extracting style information corresponding to each of the operation items the displaying of which is needed by the operation-item display information, from second style information for all the operation items that can be displayed in the Web page.

48. The method according to claim 47 wherein the operation-item creating step includes creating third style information, which is used to extract the style information corresponding to each of the operation items the displaying of which is needed by the operation-item display information, from the second style information, and the operation-item creating step is provided to create the first style information by applying the created third style information to the second style information.

49. The method according to claim 46 wherein each of the operation items is created by applying the first style information to function identification information for identifying a corresponding one of the functions for one of the operation items, so that, when one of the operation items is chosen, processing concerning the function identified by the function identification information corresponding to the chosen operation item is performed.

50. The method according to claim 49 wherein extraction function identification information is created by extracting the function identification information, corresponding to the functions the allowability of execution of which is indicated by the permitted-function identification information, from the function identification information, and the operation items are created by applying the first style information to the extraction function identification information.

51. A computer program product embodied therein to cause a computer to execute a Web page creation method which creates a Web page having operation items, the method comprising steps of:
creating first style information for each of the operation items displaying of which is needed, based on operation-item display information which is defined for a device on which the Web page is displayed or a user of the device to indicate whether the displaying of each operation item is needed; and
creating the operation items in the Web page according to the first style information created in the first creating step, so that some of the operation items the displaying of which is needed are displayed.

52. The computer program product according to claim 51 wherein the first creating step is provided to create the first style information by extracting style information corresponding to each of the operation items the displaying of which is needed by the operation-item display information, from second style information for all the operation items that can be displayed in the Web page.

53. A computer program product embodied therein to cause a computer to execute a Web page creation method which creates a Web page having operation items corresponding to functions of an external device, the method comprising steps of:
transmitting an inquiry about usable functions of the external device to the external device; and
creating the Web page based on both operation-item display information, which is defined for a device where the Web page is displayed or a user of the device to indicate whether displaying of each operation item is needed, and usable function identification information, which is received from the external device in response to the inquiry and indicates the usable functions of the external device, so that the operation items corresponding to the usable functions of the external device are displayed.

54. The computer program product according to claim 53 wherein the creating step includes:
creating first style information for each of the operation items the displaying of which is needed, based on the operation-item display information; and
creating the operation items in the Web page by applying the first style information created in the first style information creating step, to the usable function identification information.

55. A computer program product embodied therein to cause a computer to execute a Web page creation method which creates a Web page having operation items corresponding functions of different external devices respectively, the method comprising steps of:
transmitting an inquiry about allowability of execution of a corresponding one of the functions for one of the operation items, to each of the external devices; and
creating the Web page based on both operation-item display information, which is defined for a device where the Web page is displayed or a user of the device to indicate whether displaying of each operation item is needed, and permitted-function identification information, which is received from the external devices in response to the inquiry and indicates the allowability of execution of each of the functions, so that the operation items corresponding to the permitted functions of the external devices are displayed.

56. The computer program product according to claim 55 wherein the Web page creating step includes:
creating first style information for each of the operation items the displaying of which is needed, based on the operation-item display information; and
creating the operation items in the Web page by applying the created first style information to the permitted-function identification information.

57. An information processing device including a built-in communication device which communicates with an external device connected via a network, comprising:
a Web page creation unit creating a Web page having operation items corresponding to functions of the external device; and
a display unit displaying the Web page created by the Web page creation unit,
wherein the Web page creation unit creates the Web page based on both operation-item display information, which is defined for a device where the Web page is displayed or a user of the device to indicate whether displaying of each operation item is needed, and usable function identification information, which is received from the external device in response to an inquiry from the communication device and indicates the usable functions of the external device, so that the operation items corresponding to the usable functions of the external device are displayed.

58. An information processing device including a built-in communication device which communicates with a plurality of external devices connected via a network, comprising:
a Web page creation unit creating a Web page having operation items corresponding to functions of the external devices respectively; and
a display unit displaying the Web page created by the Web page creation unit,
wherein the Web page creation unit creates the Web page based on both operation-item display information, which is defined for a device where the Web page is displayed or a user of the device to indicate whether displaying of each operation item is needed, and permitted-function identification information, which is received from the external devices in response to an inquiry from the communication device and indicates the allowability of execution of each of the functions, so that the operation items corresponding to the permitted functions of the external devices are displayed.

59. A Web page creation apparatus comprising:
a Web page creation unit creating a Web page;
a first storage unit managing common information which is defined in common for two or more users to indicate operation items being displayed in the Web page;
a second storage unit managing individual information which is defined for each user to indicate operation items the displaying of which is unneeded, among all the operation items defined in the common information,
wherein the Web page creation unit is provided to create the Web page so that the operation items, extracted from all the operation items of the common information based on the individual information are displayed.
